(19) United States
(12) Patent Application Publication
(10) Pub. No.: US 2011/0276659 A1
(43) Pub. Date: Nov. 10, 2011

(54) SYSTEM AND METHOD FOR PROVIDING MULTIMEDIA SERVICE IN A COMMUNICATION SYSTEM

(75) Inventors: Bum-Suk CHOI, Daejeon (KR); Eun-Seo LEE, Daejeon (KR)

(73) Assignee: Electronics and Telecommunications Research Institute, Daejeon (KR)

(21) Appl. No.: 13/080,311

(22) Filed: Apr. 5, 2011

(30) Foreign Application Priority Data
Apr. 5, 2010 (KR) 10-2010-0031093
Apr. 1, 2011 (KR) 10-2011-0030396

(51) Int. Cl. G06F 15/16

(52) U.S. Cl. 709/219; 709/217

(57) ABSTRACT

Disclosed herein are a system and a method for providing multimedia service capable of rapidly providing various types of large-capacity multimedia contents and various sensory effects of the multimedia contents to users in real time, which receive sensory effect information representing sensory effects of multimedia contents corresponding to the multimedia services and encode the sensory effect information into command information of binary representation, depending on service requests of multimedia services that users want to receive and transmit command information of the binary representation to the user devices, respectively, so as to provide the sensory effects to the users through the device command of the user devices depending on the command information of the binary representation.

### CROSS-REFERENCES TO RELATED APPLICATIONS

The present application claims priority of Korean Patent Application Nos. 10-2010-0031093 and 10-2011-0030396, filed on Apr. 5, 2010, and Apr. 1, 2011, respectively, which are incorporated herein by reference in its (their) entirety.

### BACKGROUND OF THE INVENTION

1. Field of the Invention

Exemplary embodiments of the present invention relate to a communication system, and more particularly, to a system and a method for providing multimedia services capable of rapidly providing various types of large-capacity multimedia contents and various sensory effects of the multimedia contents to users in real time.

2. Description of Related Art

Research into a technology providing various services having quality of services (QoS) to users at a high transmission rate has been actively progressed in a communication system. Methods for providing services requested by each user by rapidly and stably transmitting various types of service data to the users through limited resources depending on service requests of users who want to receive various types of services has been proposed in the communication system.

Meanwhile, a method for transmitting large-capacity service data at high speed depending on various service requests of users has been proposed in the current communication system. In particular, research into a method for transmitting large-capacity multimedia data at high speed depending on the service requests of the users who want to receive various multimedia services. In other words, the users want to receive higher quality of various multimedia services through the communication systems. In particular, the users may receive the higher quality of multimedia services by receiving receive the multimedia contents depending on the multimedia services and various sensory effects of the multimedia contents to higher quality of multimedia services.

However, the current communication system has a limitation in providing multimedia services requested by the users by transmitting the multimedia contents depending on the multimedia service requests of the users. In particular, as described above, a method for providing the multimedia contents and the various sensory effects of the multimedia contents to the users depending on the higher quality of various multimedia service requests of the users has not yet been proposed in the current communication system. That is, a method for providing the higher quality of various multimedia services to each user in real time by rapidly transmitting the multimedia contents and the various sensory effects has not yet been proposed in the current communication system.

Therefore, a need exists for a method for providing the higher quality of various large-capacity multimedia services depending on the service requests of users in the communication system, in particular, a method for providing the higher quality of large-capacity multimedia services requested by each user in real time.

### SUMMARY OF THE INVENTION

An embodiment of the present invention is directed to provide a system and a method for providing multimedia services in a communication system.

Further, another embodiment of the present invention is directed to provide a system and a method for providing multimedia services capable of providing high quality of various multimedia services to users at high speed and in real time according to service requests of users in a communication system.

In addition, another embodiment of the present invention is directed to provide a system and a method for providing a multimedia service capable of providing high quality of various multimedia services to each user in real time by rapidly transmitting multimedia contents of multimedia services and various sensory effects of the multimedia contents that are received by each user in a communication system.

In accordance with an embodiment of the present invention, a system for providing multimedia service in a communication service includes: a user server configured to receive sensory effect information representing sensory effects of multimedia contents corresponding to the multimedia services and encode the sensory effect information into command information of binary representation to be transmitted to user devices, respectively, depending on service requests of multimedia services that users want to receive; and user devices configured to provide the multimedia contents and the sensory effects to the users through device command for command information of the binary representation in real time.

In accordance with another embodiment of the present invention, a system for providing multimedia services in a communication system includes: a receiver configured to receive sensory effect information representing sensory effects of multimedia contents corresponding to the multimedia services depending on service requests of multimedia services that users want to receive; an encoder configured to encode the sensory effect information into command information of binary representation using a binary representation encoding scheme; and a transmitter configured to transmit command information of the binary representation to the user devices, respectively, so as to provide the sensory effects to the users through the device command of the user devices depending on the command information of the binary representation.

In accordance with another embodiment of the present invention, a method for providing multimedia services in a communication system includes: receiving sensory effect information representing sensory effects of multimedia contents corresponding to the multimedia services depending on service requests of multimedia services that users want to receive; encoding the sensory effect information into command information of binary representation; and transmitting command information of the binary representation to the user devices, respectively, so as to provide the sensory effects to the users through the device command of the user devices depending on the command information of the binary representation.

### BRIEF DESCRIPTION OF THE DRAWINGS

FIG. 1 is a diagram schematically illustrating a structure of a system for providing multimedia services in accordance with an exemplary embodiment of the present invention.

FIG. 2 is a diagram schematically illustrating a structure of a service provider in the system for providing multimedia services in accordance with the exemplary embodiment of the present invention.

FIG. 3 is a diagram schematically illustrating a structure of a user server in the system for providing multimedia services in accordance with the exemplary embodiment of the present invention.

FIG. 4 is a diagram schematically illustrating a structure of a user device in the system for providing multimedia services in accordance with the exemplary embodiment of the present invention.

FIG. 5 is a diagram schematically illustrating a coordinate system of a sensory device in the system for providing multimedia services in accordance with the exemplary embodiment of the present invention.

FIG. 6 is a diagram schematically illustrating a coordinate system of sensors in the system for providing multimedia services in accordance with an exemplary embodiment of the present invention.

FIG. 7 is a diagram schematically illustrating a process of providing multimedia services of the system for providing multimedia services in accordance with the exemplary embodiment of the present invention.

### DESCRIPTION OF SPECIFIC EMBODIMENTS

Exemplary embodiments of the present invention will be described below in more detail with reference to the accompanying drawings. Only portions needed to understand an operation in accordance with exemplary embodiments of the present invention will be described in the following description. It is to be noted that descriptions of other portions will be omitted so as not to make the subject matters of the present invention obscure.

Exemplary embodiments of the present invention proposes a system and a method for providing multimedia services capable of providing high quality of various multimedia services at high speed and in real time in a communication system. In the exemplary embodiments of the present invention provide high quality of various multimedia services requested by each user in real time by transmitting multimedia contents of multimedia services and various sensory effects of the multimedia contents provided to each user at high speed, depending on service requests of users that want to receive high quality of various services.

Further, the exemplary embodiments of the present invention transmit the multimedia contents of the multimedia services and the various sensory effects of the above-mentioned multimedia contents at high speed by maximally using available resources so as to provide multimedia services to users. In this case, the multimedia contents of the multimedia services that the users want to receive are large-capacity data. Most of the available resources are used to transmit the multimedia contents. Therefore, the available resources are more limited so as to transmit the various sensory effects of the multimedia contents that are essentially transmitted and provided so as to provide high quality of various multimedia services requested by users. As a result, there is a need to transmit the large-capacity multimedia contents and the various sensory effects at high speed so as to provide high quality of various multimedia services to users at high speed and in real time.

That is, the exemplary embodiments of the present invention, in order to provide the multimedia services requested by each user at high speed and in real time through available resources so as to provide the high quality of various multimedia services, the data size of the sensory effect information is minimized by encoding the multimedia contents are encoded, in particular, encoding information (hereinafter, referred to as “sensory effects information”) representing the various sensory effects of the multimedia contents using binary representation, such that the multimedia contents and the various sensory effects of the multimedia contents are rapidly transmitted and the multimedia contents and the sensory effects are provided to each user in real time, that is, the high quality of various multimedia services are provided to the user in real time.

Further, the exemplary embodiments of the present invention provide the multimedia contents services and the various sensory effects of the multimedia contents to each user receiving the multimedia in real time by transmitting information on the various sensory effects of the multimedia using the binary representation encoding scheme at high speed in a moving picture experts group (MPEG)-V, that is, transmitting sensory effect data or sensory effect metadata using the binary representation at high speed.

In this case, the exemplary embodiments of the present invention relate to the sensory effect information, that is, the high speed transmission of the sensory effect data or the sensory effect metadata, in Part 5 of MPEG-V. The exemplary embodiments of the present invention allows the user server, for example, the home server to encode the various sensory effects of the multimedia contents using the binary representation, that is, the sensory effect information using the binary representation encoding scheme, wherein the user server, for example, the home server receives the multimedia contents of the multimedia services and the sensory effect information on the multimedia contents from a service provider generating, providing, or selling the high quality of various multimedia services, depending on the service requests of each user.

In this case, the service provider may encode and transmit the sensory effect information using the binary representation. When the sensory information is transmitted by being encoded by the binary representation, the sensory effect information is transmitted at high speed by maximally using the very limited available resources to transmit the sensory effect information, that is, the remaining available resources other than the resources used to transmit the large-capacity multimedia contents. Therefore, the service provider transmits the multimedia contents and the sensory effect information to the user server at high speed, such that it provides the multimedia contents and the various sensory effects of the multimedia contents to each user in real time.

In this case, the user server outputs the multimedia services and transmits the multimedia contents and the sensory effect information to the user devices that provide the actual multimedia services to each user. In this case, the user server encodes the sensory effect information using the binary representation, converts the encoded sensory effect information into command information for device command of each user device, and transmits the command information converted into the binary representation to each user device. Meanwhile, each user device is commanded depending on the command information converted into the binary representation to output the various sensory effects, that is, provide the multimedia contents to the users and provide the various sensory effects of the multimedia contents in real time.

For example, in the above-mentioned Part 5 of MPEG-V, the various sensory effects that may indicated the scene of the multimedia contents or the actual environment are defined a schema for effectively describing the various sensory effects. For example, when wind blows in a specific scene of a movie, the sensory effect like the wind blows is described using a predetermined schema and is inserted into the multimedia data. When the home server reproduces a movie through the multimedia data, the home server provides the sensory effect like the wind blows to the user by extracting the sensory effect information from the multimedia data and then, being synchronized with a user device capable of outputting the wind effect like a fan. Further, as another example, a trainee (that is, a user) purchasing the user devices capable of giving the various sensory effects is in the house and a lecturer (that is, a service provider) gives a lecture (that is, transmit multimedia data) from a remote and transmits the various sensory effects depending on course content (that is, multimedia contents) to a trainee, thereby providing more realistic education, that is, higher quality of multimedia services.

In order to provide the high quality of multimedia services, the sensory effect information simultaneously provided the multimedia contents may be described as an eXtensible markup language (hereinafter, referred to as “XML”) document. For example, when the service provider described the sensory effect information as the XML document, the sensory effect information is transmitted to the user server as the XML document and the user server receiving the sensory effect information on the XML document analyzes the XML document and then, analyzes the sensory effect information on the analyzed XML document.

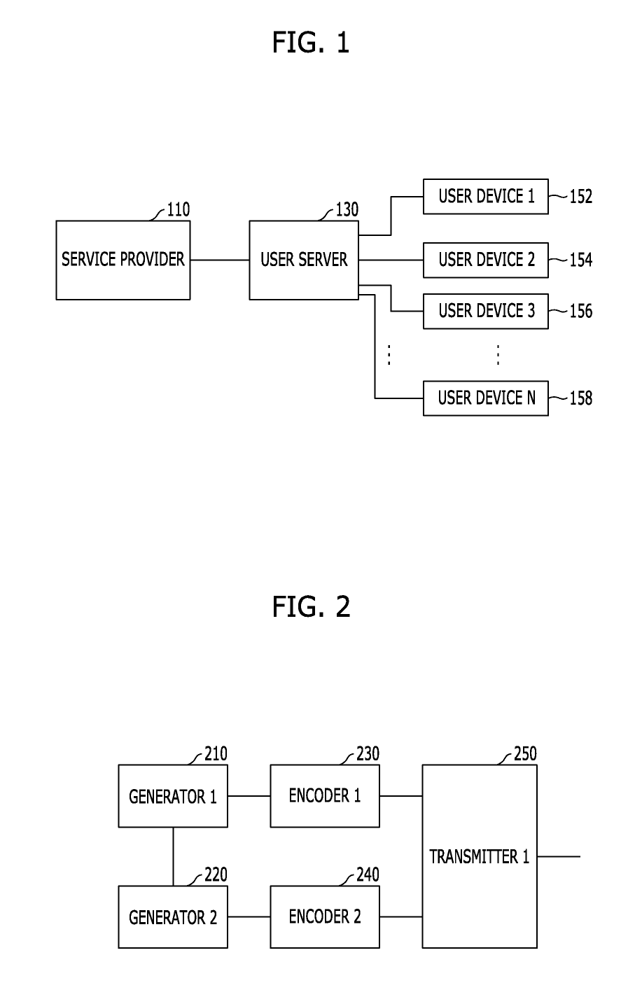

In this case, the user devices may have a limitation in providing the high quality of various multimedia services to the users at high speed and in real time depending on the analysis of the XML document and the sensory effect information. However, the exemplary embodiments of the present invention encode and transmit the sensory effect information using the binary representation as described above, such that the analysis of the XML document and the sensory effect information is unnecessary and the high quality of various multimedia services are provided to the users at high speed and in real time. In other words, in the exemplary embodiments of the present invention, in Part 5 of MPEG-V, the sensory effect information is compressed and transmitted using the binary representation encoding scheme rather than the XML document, such that the number of bits used to transmit the sensory effect information is reduced, that is, the amount of resources used to transmit the sensory effect information is reduced, and the analysis process of the XML document and the sensory effect information is omitted to effectively transmit the sensory effect information at high speed. A system for providing multimedia services in accordance with an exemplary embodiment of the present invention will be described in more detail with reference to FIG. 1.

FIG. 1 is a diagram schematically illustrating a structure of a system for providing multimedia services in accordance with an exemplary embodiment of the present invention.

Referring to FIG. 1, the system for providing multimedia services includes a service provider 110 configured to generate, provide, or sell high quality of various multimedia services that each user wants to receive depending on service requests of users, a user server 130 configured to transmit and transmit multimedia services provided from the service provider 110 to the users, a plurality of user devices, for example, a user device 1 152, a user device 2 154, a user device 3 156, and a user device N 158 configured to output the multimedia services transmitted from the user server 130 and substantially provide the output multimedia services to the users.

As described above, the service provider 110 generates the multimedia contents of the multimedia services that each user wants to receive depending on the service requests of users and generates the sensory effect information so as to provide the various sensory effects of the multimedia contents to each user. Further, the service provider 110 encodes the multimedia contents and the sensory effect information to be transmitted to the user server 130 at high speed.

As described above, the service provider 110 encodes the sensory effect information using the binary representation, that is, encodes the sensory effect information using the binary representation encoding scheme, such that the data size of the sensory effect information is minimized and the sensory effect information of the binary representation having the minimum data size is transmitted to the user server 130. Therefore, the service provider 110 maximally uses the available resources so as to provide the multimedia services to transmit the multimedia data at high speed. In particular, the service provider 110 transmits the encoded multimedia contents and the sensory effect information encoded by the binary representation as the multimedia data to the user server 130. That is, the multimedia data includes the encoded multimedia contents and the sensory effect information encoded by the binary representation and is transmitted to the user server 130.

In this case, the service provider 110 may be a contents provider generating the multimedia services or a communication provider providing or selling the multimedia services, a service vendor, or the like. The service provider 100 will be described in more detail with reference to FIG. 2 and the description thereof will be omitted.

Further, the user server 130 receives the multimedia data from the service provider 110 and transmits the multimedia contents included in the multimedia data to the corresponding user device, for example, the user device 1 152 and converts the sensory effect information encoded by the binary representation included in the multimedia data into command information to be transmitted to the corresponding user devices, for example, the user device 2 154, the user device 3 156, and the user device N 158, respectively. As described above, the user server 130 may receive the sensory effect information on the multimedia contents from the service provider 110 as the sensory effect information encoded by the binary representation, but may also receive the sensory effect information on the XML document from other general service providers in Part 3 of MPEG-V.

In this case, when the user server 130 receives the sensory effect information encoded by the binary representation, it converts the sensory effect information into the command information using the binary representation and then, encodes the converted command information using the binary representation to transmit the command information encoded by the binary representation to the user devices 152, 154, 156, and 158, respectively, or transmit the sensory effect information of the binary representation as the command information to the user devices 152, 154, 156, and 158, respectively. In addition, when the user server 130 receives the sensory effect information on the XML document, it converts the sensory effect information on the XML document into the command information and then, encodes the converted command information using the binary representation to transmit the command information encoded by the binary representation to the user devices 152, 154, 156, and 158, respectively.

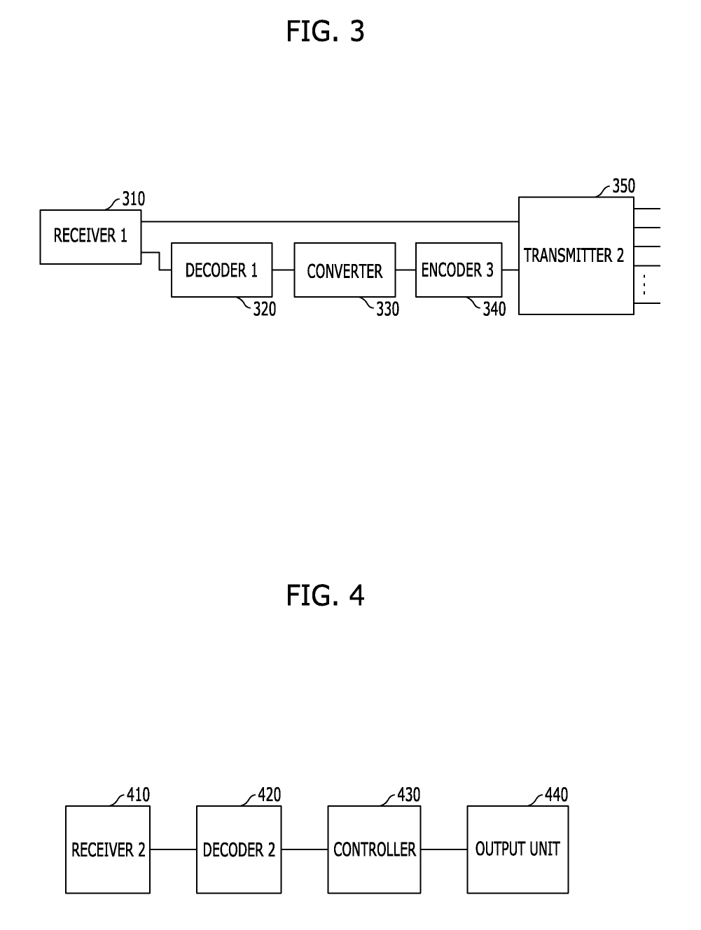

In this case, the user server 130 may be a terminal receiving the multimedia data from the service provider 110, a server, for example, a home server commanding and managing the user devices 152, 154, 156, and 158 outputting and providing the multimedia contents and the various sensory effects of the multimedia contents to the actual users, or the like. The user server 130 will be described in more detail with reference to FIG. 3 and the description thereof will be omitted.

Further, the user devices 152, 154, 156, and 158 receive the multimedia contents and the command information from the user server 130 to output, that is, provide the actual multimedia contents and the various sensory effects of the multimedia contents to each user. In this case, the user devices 152, 154, 156, and 158 include the user device that outputs the multimedia contents, that is, outputs video and audio of the multimedia contents, for example, the user device 1 152 and the user devices 154, 156, and 158 outputting the various sensory effects of the multimedia contents, respectively.

As described above, the user device 1 152 outputs the video and audio of the multimedia services that the users want to receive and provides the video and audio to the users. The remaining user devices 154, 156, and 158 each receive the command information encoded by the binary representation from the user server 130 and are commanded depending on the command information encoded by the binary representation to output the corresponding sensory effects. In particular, the remaining user devices 154, 156, and 158 is the command information outputting the sensory effect while outputting the video and audio of the multimedia services and outputs the sensory effects at high speed, corresponding to the command information encoded by the binary representation without analyzing the command information depending on the receiving of the command information encoded by the binary representation, thereby providing the sensory effects to the users in real time while outputting the video and audio of the multimedia services.

In this case, the user devices 152, 154, 156, and 158 may be a video display and a speaker that outputs video and audio, various devices outputting the various sensory effects, for example, home appliances such as a fan, an air conditioner, a humidifier, a heat blower, a boiler, or the like. That is, the user devices 152, 154, 156, and 158 are commanded depending on the command information encoded by the binary representation to provide the high quality of multimedia services to the users in real time. In other words, the user devices 152, 154, 156, and 158 provide video and audio, that is, the multimedia contents of the multimedia services and at the same time, provide the various sensory effects in real time. In this case, the various sensory effects of the multimedia contents may be, for example, a light effect, a colored light effect, a flash light effect, a temperature effect, a wind effect, a vibration effect, a water sprayer effect as a spraying effect, a scent effect, a fog effect, a color correction effect, a motion and feeling effect (for example, rigid body motion effect), a passive kinesthetic motion effect, a passive kinesthetic force effect, an active kinesthetic effect, a tactile effect, or the like. The user devices 152, 154, 156, and 158 will be described in more detail with reference to FIG. 4 and the detailed description thereof will be omitted.

In the system for providing multimedia services in accordance with the exemplary embodiment of the present invention, the service provider 110 generates the sensory effect information in real time depending on the multimedia contents, obtains the sensory effect information on the XML document and the service provider 110 encodes the sensory effect information using the binary representation as descried above and transmits the sensory effect information encoded by the binary representation to the user server 130 through the network.

In other words, the system for providing multimedia services in accordance with the exemplary embodiment of the present invention, the service provider 110 encodes the sensory effect information on the multimedia contents using the binary representation encoding scheme in Part 3 of MPEG-V and transmits the sensory effect information and the multimedia contents encoded by the binary representation as the multimedia data to the user server 130. Therefore, the system for providing multimedia services maximally uses the network usable to provide the multimedia services to transmit the multimedia data, in particular, encodes the sensory effect information using the binary representation encoding scheme to minimize the data size of the sensory effect information, thereby transmitting the multimedia data to the user server 130 at high speed and in real time.

The user server 130 receives the sensory effect information encoded by the binary representation to acquire the sensory effect information for providing the high quality of various multimedia services to the users at high speed and converts the acquired sensory effect information into the command information and encodes the converted command information using the binary representation to be transmitted to each user device 152, 154, 156, and 158. In addition, each user device 152, 154, 156, and 158 is subjected to the device command depending on the command information encoded by the binary representation to simultaneously provide the various sensory effects and the multimedia contents to the users in real time. In the system for providing multimedia services in accordance with the exemplary embodiment of the present invention, the service provider 110 will be described in more detail with reference to FIG. 2.

FIG. 2 is a diagram schematically illustrating a structure of a service provider in the system for providing multimedia services in accordance with the exemplary embodiment of the present invention.

Referring to FIG. 2, the service provider 110 includes a generator 1 210 configured to generate the multimedia contents of the multimedia services that the each user want to receive depending on the service requests of users, a generator 2 220 configured to generate information representing the various sensory effects of the multimedia contents, that is, acquire the sensory effect information or the sensory effect information on the XML document, an encoder 1 230 configured to encode the multimedia contents, an encoder 2 240 configured to encode the sensory effect information using the binary representation encoding scheme, and a transmitter 1 250 configured to transmit the multimedia data including the encoded multimedia contents and the sensory effect information to the user server 130.

The generator 1 210 generates the multimedia contents corresponding to the high quality of various multimedia services that the users want to receive or receives and acquires the multimedia contents from external devices. Further, the generator 2 220 generates the sensory effect information on the multimedia contents so as to provide the various sensory effects while the multimedia contents or receives and acquires the sensory effect information on the XML document from the external devices, thereby providing the high quality of various multimedia services to the users.

The encoder 1 230 uses the predetermined encoding scheme to encode the multimedia contents. Further, the encoder 2 240 encodes the sensory effect information using the binary representation encoding scheme, that is, using the binary representation. In this case, the sensory effect information is encoded using the binary code in a stream form. In other words, the encoder 2 240 is a sensory effect stream encoder and outputs the sensory effect information as the sensory effect stream encoded by the binary representation.

In this case, the encoder 2 240 minimizes the data size of the sensory effect information by encoding the sensory effect information using the binary representation and as described above, the user server 130 receives the sensory effect information of the binary representation to confirm the sensory effect information through stream decoding of the binary code without analyzing the sensory effect information and converts the confirmed sensory effect information into the command information.

The transmitter 1 250 transmits the multimedia data including the multimedia contents and the sensory effect information to the user server 130, that is, transmits the encoded multimedia contents and the sensory effect information encoded using the binary code to the user server 130. As described above, as the sensory effect information is transmitted while being encoded using the binary code in the stream form, that is, transmitted as the sensory effect information stream encoded by the binary representation, the transmitter 1 250 maximally uses the available resources to transmit the multimedia data to the user server 130 at high speed and in real time. In the system for providing multimedia services in accordance with the exemplary embodiment of the present invention, the service provider 130 will be described in more detail with reference to FIG. 3.

FIG. 3 is a diagram schematically illustrating a structure of a user server in the system for providing multimedia services in accordance with the exemplary embodiment of the present invention.

Referring to FIG. 3, the user server 130 includes a receiver 1 310 configured to receive the multimedia data from the service provider 110, a decoder 1 320 configured to decode the sensory effect information encoded by the binary representation in the received multimedia data as described above, a converter 330 configured to convert the decoded sensory effect information into the command information for commanding the devices of each user devices 152, 154, 156, and 158, an encoder 3 340 configured to encode the converted command information using the binary representation encoding scheme, and a transmitter 2 350 configured to transmit the multimedia contents in the multimedia data and the command information encoded by the binary representation to each user device 152, 154, 156, and 158.

As described above, the receiver 1 310 receives the multimedia data including the multimedia contents and the sensory effect information on the multimedia contents encoded by the binary representation from the service provider 110. In this case, the receiver 1 310 may also receive the multimedia data including the multimedia contents and the sensory effect information on the XML document from other service providers

The decoder 1 320 decodes the sensory effect information encoded by the binary representation in the multimedia data. In this case, since the sensory effect information encoded by the binary representation is the sensory effect stream encoded using the binary code in the stream form, the decoder 1 320, which is a sensory effect stream decoder, decodes the sensory effect stream encoded by the binary representation and the decoded sensory effect information is transmitted to the converter 330. In addition, when the receiver 1 310 receives the multimedia data including the sensory effect information on the XML document, the decoder 1 320 analyzes and confirms the sensory effect information on the XML document and transmits the confirmed sensory effect information to the converter 330.

The converter 330 converts the sensory effect information into the command information for commanding the devices of the user devices 152, 154, 156, and 158. In this case, the converter 330 converts the sensory effect information into the command information in consideration of the capability information on the user devices 152, 154, 156, and 158.

In this case, the receiver 1 310 of the user server 130 receives the capability information on the user devices 152, 154, 156, and 158 from all the user devices 152, 154, 156, and 158, respectively. In particular, as described above, as the user server 130 manages and controls the user devices 152, 154, 156, and 158, the user devices 152, 154, 156, and 158 each transmit the capability information to the user server 130 at the time of the initial connection and setting to the user server 130 of the user devices 152, 154, 156, and 158 for providing the multimedia services.

Therefore, the converter 330 converts the sensory effect information into the command information so as to allow the user devices 152, 154, 156, and 158 to accurately output the sensory effects indicated by the sensory effect information in consideration of the capability information, that is, accurately provide the sensory effect of the multimedia contents depending on the sensory effect information to the users in real time and the user devices 152, 154, 156, and 158 accurately provides the sensory effect of the multimedia contents to the users in real time by the device command of the command information

The encoder 3 340 encodes the converted command information using the binary encoding scheme, that is, encodes the command information using the binary representation. In this case, the command information is encoded using the binary code in the stream form. In other words, the encoder 3 340 becomes the device command stream encoder and outputs the command information for commanding the devices as the device command stream encoded by the binary representation. In this case, the sensory effect information and the binary representation encoding of the sensory effect information will be described in more detail below and the detailed description thereof will be omitted.

In addition, the encoder 3 340 defines syntax, binary representation, and semantics of the sensory effects corresponding to the sensory effect information at the time of the binary representation encoding of the sensory effect information. Further, as the command information is encoded by the binary representation, the command information of the binary representation becomes each user device 152, 154, 156, and 158. The user devices 152, 154, 156, and 158 each receive the command information of the binary representation to perform the device command through the stream decoding of the binary code without analyzing the command information, thereby outputting the sensory effect. In addition, as described above, the receiver 1 310 of the user server 130 receives the sensory information on the multimedia contents from the service provider 110 as the sensory effect information encoded by the binary representation and the sensory effect information on the XML document.

In more detail, when the receiver 1 310 receives the sensory effect information encoded by the binary representation, as described above, the decoder 1 320 performs stream decoding on the sensory effect information encoded by the binary representation and the converter 330 converts the sensory effect information into the command information in consideration of the capability information on the user devices 152, 154, 156, and 158 and then, the encoder 3 340 encodes the converted command information using the binary representation, wherein the command information encoded by the binary representation are transmitted to the user devices 152, 154, 156, and 158, respectively.

Further, when the receiver 1 310 receives the sensory effect information encoded by the binary representation, as described above, the user server 130 transmits the sensory effect information of the binary representation as the command information to the user devices 152, 154, 156, and 158, respectively, the decoder 1 320 performs the stream decoding on the sensory effect information encoded by the binary representation and does not perform the command information conversion operation in the converter 330 and the encoder 3 340 encodes the decoded sensory effect information using the binary representation in consideration of the capability information of the user devices 152, 154, 156, and 158 In other words, the encoder 3 340 outputs the sensory effect information of the binary representation encoded in consideration of the capability information as the command information encoded by the binary representation for performing the device command of the user devices 152, 154, 156, and 158, respectively, wherein the command information encoded by the binary representation is transmitted to the user devices 152, 154, 156, and 158, respectively.

Further, when the receiver 1 310 receives the sensory effect information of the XML document, the decoder 1 320 analyzes and confirms the sensory effect information of the XML document and the converter 330 converts the confirmed sensory effect information into the command information in consideration of the capability information of the user devices 152, 154, 156, and 158 and then, the encoder 3 340 encodes the converted command information using the binary representation, wherein the command information encoded by the binary representation are transmitted to the user devices 152, 154, 156, and 158, respectively.

For example, when the user server 130 receives the sensory effect information of the binary representation or the sensory effect information of the XML document including a two-level wind effect (as an example, wind blowing of 2 m/s magnitude), the user server 130 confirms the user device providing the wind effect through the capability information of the user devices 152, 154, 156, and 158, for example, confirms a fan and transmits the device command so as for the fan to output the two-level wind effect through the capability information of the fan, that is, the command information of the binary representation commanding the fan to be operated as three level (herein, the user server 130 confirms that the fan outputs the wind at a size of 2 m/s when being operated at 3 level through the capability information of the fan) to the fan. Further, the fan receives the command information of the binary representation from the user server 130 and then, decodes the command information of the binary representation to be operated as three level, such that the users receives the effect like the wind having a size of 2 m/s blows in real time while viewing the multimedia contents.

The transmitter 2 350 transmits the multimedia contents included in the multimedia data and the command information encoded by the binary representation to the user devices 152, 154, 156, and 158, respectively. In this case, the command information encoded by the binary representation is transmitted to the user devices 152, 154, 156, and 158 in the stream form. The user devices 152, 154, 156, and 158 in the system for providing multimedia services in accordance with the exemplary embodiment of the present invention will be described in more detail with reference to FIG. 4.

FIG. 4 is a diagram schematically illustrating a structure of a user device in the system for providing multimedia services in accordance with the exemplary embodiment of the present invention.

Referring to FIG. 4, the user device includes a receiver 2 410 configured to receive the multimedia contents or the command information encoded by the binary representation from the user server 130, a decoder 2 420 configured to decode the multimedia contents or the command information encoded by the binary representation, a controller 430 configured to perform the device command depending on the decoded command information, and an output unit 440 configured to provide the high quality of various multimedia services to the user by outputting the multimedia contents or the various sensory effects of the multimedia contents.

The receiver 2 410 receives the multimedia contents transmitted from the transmitter 2 350 of the user server 130 or receives the command information encoded by the binary representation. In this case, the command information encoded by the binary representation is transmitted in the stream form and the receiver 2 410 receives the command information stream encoded by the binary representation. In addition, as described above, when the user device uses the user device outputting the multimedia contents, that is, video and audio of the multimedia services, the receiver 2 410 receives the multimedia contents and the decoder 420 decodes the multimedia contents and then, the output unit 440 outputs the multimedia contents, that is, the video and audio of the multimedia services to the user. Hereinafter, for convenience of explanation, the case in which the receiver 2 410 receives the command information encoded by the binary representation, that is, the case in which the user device is a device providing the various sensory effects of the multimedia contents to the users will be mainly described.

The decoder 2 420 decodes the command information of the binary representation received in the stream form. In this case, since the command information encoded by the binary representation is the command information stream encoded by the binary code in the stream form, the decoder 2 420, which is the device command stream decoder, decodes the command information stream encoded by the binary representation and transmits the decoded command information as the device command signal to the controller 430.

The controller 430 receives the command information as the command signal from the decoder 2 420 and performs the device command depending on the command information.

That is, the controller 430 controls the user device to provide the sensory effect of the multimedia contents to the user depending on the command information. In this case, the sensory effects are output at high speed by transmitting the command information is encoded without performing the analysis and confirmation of the command information by the binary representation from the user server 130, such that the user device simultaneously provides the sensory effects and the multimedia contents to the users in real time.

In other words, when the receiver 2 410 receives the command information of the XML document, the decoder 2 420 analyzes and confirms the command information of the XML document and the controller 430 outputs the sensory effect through the device command depending on the confirmed command information. In this case, the sensory effects may not be output at high speed by performing the analysis and confirmation of the command information, such that the user device does not simultaneously provide the sensory effect and the multimedia contents to the users in real time. However, since the user server 130 of the multimedia service providing system in accordance with the exemplary embodiment of the present invention encodes the command information using the binary representation in consideration of the capability information of the user devices 152, 154, 156, and 158 to be transmitted to the user devices 152, 154, 156, and 158, respectively, each user device 152, 154, 156, and 158 outputs the sensory effects at high speed without performing the analysis and confirmation operations of the command information, such that each user device 152, 154, 156, and 158 simultaneously provides the sensory effects and the multimedia contents to the users in real time.

The output unit 440 outputs the sensory effects of the multimedia contents, corresponding to the device command depending on the command information of the binary representation. Hereinafter, the device command and the command information and the binary representation encoding of the command information of the user server 130 will be described in more detail.

First, describing types of sensory devices and sensors, the device command, the sensory capability, and the user sensory preference may be represented by the binary representation as the following Table 1. That is, the device command, the sensory capability, and the user sensory preference represented in Table 1 are encoded by the binary representation. In this case, Table 1 is a table representing the device command, the sensory capability, and the user sensory preference.

TABLE 1

| | Binary representation for device |
|---|---|
| Terms of Device | type (5 bits) |
| Light device | 00000 |
| Flash device | 00001 |
| Heating device | 00010 |
| Cooling device | 00011 |
| Wind device | 00100 |
| Vibration device | 00101 |
| Sprayer device | 00110 |
| Fog device | 00111 |
| Color correction device | 01000 |
| Initialize color correction | 01001 |
| parameter device | |
| Rigid body motion device | 01010 |
| Tactile device | 01011 |
| Kinesthetic device | 01100 |
| Reserved | 01101-11111 |

In addition, the sensed information and the sensor capability may be represented by the binary representation as represented in the following Table 2. That is, the device command, the sensory capability, and the user sensory preference represented in Table 2 are encoded by the binary representation. Herein, Table 2 is a table representing the sensed information and the sensing capability.

TABLE 2

| Terms of SensorBinary | |
|---|---|
| representation for sensor | |
| type | |
| (5 bits) | |
| Light sensor | 00000 |
| Ambient noise sensor | 00001 |
| Temperature sensor | 00010 |
| Humidity sensor | 00011 |
| Distance sensor | 00100 |
| Atmospheric sensor | 00101 |
| Position sensor | 00110 |
| Velocity sensor | 00111 |
| Acceleration sensor | 01000 |
| Orientation sensor | 01001 |
| Angular velocity sensor | 01010 |
| Angular acceleration | 01011 |
| sensor | |
| Force sensor | 01100 |
| Torque sensor | 01101 |
| Pressure sensor | 01110 |
| Motion sensor | 01111 |
| Intelligent camera sensor | 10000 |
| Reserved | 10001-11111 |

Next, describing a root element of the command information, an XML representation syntax of the root element may be represented as the following Table 3. Table 3 is a table representing the XML representation syntax of the root element.

TABLE 3

| <!-- ################################################--> | |
|---|---|
| <!-- Root and Top-Level Elements | --> |

<!-- ################################################-->
<element name=“InteractionInfo”
type=“iidl:InteractionInfoType”/>
<complexType name=“InteractionInfoType”>

<choice>

<element name=“DeviceCommandList”

type=“iidl:DeviceCmdListType”/>

<element name=“SensedInfoList”

type=“iidl:SensedInfoListType”/>

</choice>

</complexType>
<complexType name=“SensedInfo”>

<sequence>

<element name=“SensedInfo”

type=“iidl:SensedInfoBaseType” maxOccurs=“unbounded”/>

</sequence>

</complexType>
<complexType name=“DeviceCmdListType”>

<sequence>

<element name=“DeviceCommand”

type=“iidl:DeviceCommandBaseType” maxOccurs=“unbounded”/>

</sequence>

</complexType>

Further, the binary encoding representation scheme or the binary representation of the syntax represented in Table 3 may be represented as the following Table 4. Herein, Table 4 is a table representing the binary representation syntax.

TABLE 4

| | |
|---|---|
| (Number of | |
| bits) | (Mnemonic) |

InteractionInfo {

| | | |
|---|---|---|
| InteractionType | 1 | bslbf |
| If (InteractionType){ | | |

| | |
|---|---|
| DeviceCommandList | DeviceCmdListType |

}else{

| | |
|---|---|
| SensedInfoList | SensedInfoListType |

}

}

SensedInfoListType{

| | | |
|---|---|---|
| NumOfSensedInfo | 32 | uimsbf |

| | | |
|---|---|---|
| for(i=1;i<NumOfSensedInfo;i+ | | |
| +){ | | |
| IndividualSensedInfoType | 8 | bslbf |

SensedInfo

SensedInfoType specified
by IndividualSensedInfoType

}

}

}
DeviceCmdListType{

| | | |
|---|---|---|
| NumOfDeviceCmd | 32 | uimsbf |

| | | |
|---|---|---|
| for(i=1;i<NumOfDeviceCmd;i++ | | |
| ){ | | |
| IndividualDeviceCmdType | 8 | bslbf |

DeviceCmd

DeviceCmdType specified
by IndividualDeviceCmdType

}

}

In addition, the semantics of the root element are as represented in the following Table 5. Herein, Table 5 is a table representing semantics of the SEM.

TABLE 5

| Names | Description |
|---|---|
| InteractionType | Uppermost element name (This field, which |
| | is only present in the binary representation, |
| | indicates the type of the InteractionInfo |
| | element. If it is 1 then the |
| | DeviceCommandList element is present, |
| | otherwise the SensedInfoList element is |
| | present). |
| DeviceCommandList | Element including device |
| | command information |
| | (Optional wrapper element that serves as the |
| | placeholder for the sequence of device |
| | commands). |
| InteractionInfo | Type of uppermost element |
| Type | |
| SensedInfoList | Element including information acquired from |
| | sensor (Optional wrapper element that serves |
| | as the placeholder for the list of |
| | information acquired through sensors). |
| SensedInfoListType | Type of SensedInfoList element (A type that |
| | serves as the placeholder for the list of |
| | information acquired through sensors). |
| SensedInfoBaseType | Base type of SensedInfo |
| NumOfSensedInfo | This field, which is only present in the |
| | binary representation, specifies the number |
| | of SensedInfo instances accommodated in the |
| | SensedInfoList. |
| IndividualSensedInfoType | This field, which is only present in the |
| | binary representation, describes which |
| | SenseInfo type shall be used. |
| | In the binary description, the following |
| | mapping table is used. |
| SensedInfo | Element including information input from |
| | sensor (Specifies single description of |
| | information acquired through a sensor. The |
| | list of single commands are as follows). |
| DeviceCommandListType | Type of DeviceCommandList element (A type |
| | that serves as the placeholder for the |
| | sequence of device commands). |
| NumOfDeviceCmd | This field, which is only present in the |
| | binary representation, specifies the number |
| | of DeviceCmd instances accommodated in the |
| | DeviceCommandList. |
| IndividualDeviceCmdType | This field, which is only present in the |
| | binary representation, describes which |
| | DeviceCmd type shall be used. |
| | In the binary description, the following |
| | mapping table is used. |
| DeviceCmd | Element including device single command |
| | information (Specifies single command for a |
| | certain device. The list of single commands |
| | are as follows). |
| DeviceCommandBaseType | Base type of DeviceCommand |

SEM semantics represented in Table 5, individual sensed info type may be represented by the binary representation as represented in the following Table 6. That is, in the SEM semantics represented in Table 5, the individual sensed info type is encoded by the binary representation. Herein, Table 6 is a table representing the binary representation of the individual sensed info type.

TABLE 6

| | Binary representation for sensor |
|---|---|
| Term of Sensor | type (5 bits) |
| Light sensor | 00000 |
| Ambient noise sensor | 00001 |
| Temperature sensor | 00010 |
| Humidity sensor | 00011 |
| Distance sensor | 00100 |
| Atmospheric pressure | 00101 |
| Sensor | |
| Position sensor | 00110 |
| Velocity sensor | 00111 |
| Acceleration sensor | 01000 |
| Orientation sensor | 01001 |
| Angular velocity sensor | 01010 |
| Angular acceleration | 01011 |
| sensor | |
| Force sensor | 01100 |
| Torque sensor | 01101 |
| Pressure sensor | 01110 |
| Motion sensor | 01111 |
| Intelligent camera | 10000 |
| sensor | |
| Reserved | 10001-11111 |

Further, the SEM semantics represented in Table 5, the sensed info type may be represented by the binary representation as represented in the following Table 7. That is, in the SEM semantics represented in Table 5, the sensed info type is encoded by the binary representation. Herein, Table 7 is a table representing the binary representation of the sensed info.

TABLE 7

| | Sensed info. |
|---|---|
| Term of Sensor | type |
| Light sensor | LightSensorType |
| Ambient noise sensor | AmbientNoiseSensorType |
| Temperature sensor | TemperatureSensorType |
| Humidity sensor | HumiditySensorType |
| Distance sensor | DistanceSensorType |
| Atmospheric pressure | AtmosphericPressureSensorType |
| Sensor | |
| Position sensor | PositionSensorType |
| Velocity sensor | VelocitySensorType |
| Acceleration sensor | AccelerationSensorType |
| Orientation sensor | OrientationSensorType |
| Angular velocity sensor | AngularVelocitySensorType |
| Angular acceleration | AngularAccelerationSensorType |
| sensor | |
| Force sensor | ForceSensorType |
| Torque sensor | TorqueSensorType |
| Pressure sensor | PressureSensorType |
| Motion sensor | MotionSensorType |
| Intelligent camera | IntelligentCameraType |
| sensor | |

Further, the SEM semantics represented in Table 5, an individual device Cmd type may be represented by the binary representation as represented in the following Table 8. That is, in the SEM semantics represented in Table 5, the individual device Cmd type is encoded by the binary representation. Herein, Table 8 is a table representing the binary representation of the individual device Cmd type.

TABLE 8
Terms of Device

| | Binary representation for device |
|---|---|
| | type (5 bits) |
| Light device | 00000 |
| Flash device | 00001 |
| Heating device | 00010 |
| Cooling device | 00011 |
| Wind device | 00100 |
| Vibration device | 00101 |
| Sprayer device | 00110 |
| Scent device | 00111 |
| Fog device | 01000 |
| Color correction device | 01001 |
| Initialize color | 01010 |
| correction parameter | |
| device | |
| Rigid body motion | 01011 |
| device | |
| Tactile device | 01100 |
| Kinesthetic device | 01101 |
| Reserved | 01110-11111 |

Further, the SEM semantics represented in Table 5, the device Cmd may be represented by the binary representation as represented in the following Table 9. That is, in the SEM semantics represented in Table 5, the device command is encoded by the binary representation. Herein, Table 9 is a table representing the binary representation of the device command.

TABLE 9

| | Device command |
|---|---|
| Terms of Device | type |
| Light device | LightType |
| Flash device | FlashType |
| Heating device | HeatingType |
| Cooling device | CoolingType |
| Wind device | WindType |
| Vibration device | VibrationType |
| Sprayer device | SprayerType |
| Scent device | ScentType |
| Fog device | FogType |
| Color correction device | ColorCorrectionType |
| Initialize color | InitializeColorCorrectionParameterType |
| correction parameter | |
| device | |
| Rigid body motion | RigidBodyMotionType |
| device | |
| Tactile device | TactileType |
| Kinesthetic device | KinestheticType |

That is, in the root element, the device command type ID may be represented as Table 10 and the sensed info type ID may be represented as Table 11. Herein, Table 10 is a table representing the device Cmd type ID and Table 11 is a table representing the sensed info type ID.

TABLE 10

| ID | Device Command Type |
|---|---|
| 0 | Forbidden |
| 1 | Light type |
| 2 | Flash type |
| 3 | Heating type |
| 4 | Cooling type |
| 5 | Wind type |
| 6 | Vibration type |
| 7 | Sprayer type |
| 8 | Scent type |
| 9 | Color correction type |
| 10 | Rigid body motion type |
| 11 | Tactile type |
| 12 | Kinesthetic type |
| 13~255 | Reserved |

TABLE 11

| ID | Sensed Info. Type |
|---|---|
| 0 | Forbidden |
| 1 | Light Sensor type |
| 2 | Ambient noise sensor type |
| 3 | Temperature sensor type |
| 4 | Humidity sensor type |
| 5 | Distance sensor type |
| 6 | Atmospheric pressure sensor type |
| 7 | Position sensor type |
| 8 | Velocity sensor type |
| 9 | Acceleration sensor type |
| 10 | Orientation sensor type |
| 11 | Angular velocity sensor type |
| 12 | Angular acceleration sensor type |
| 13 | Force sensor type |
| 14 | Torque sensor type |
| 15 | Pressure sensor type |
| 16 | Motion sensor type |
| 17 | Intelligent camera type |
| 18~255 | Reserved |

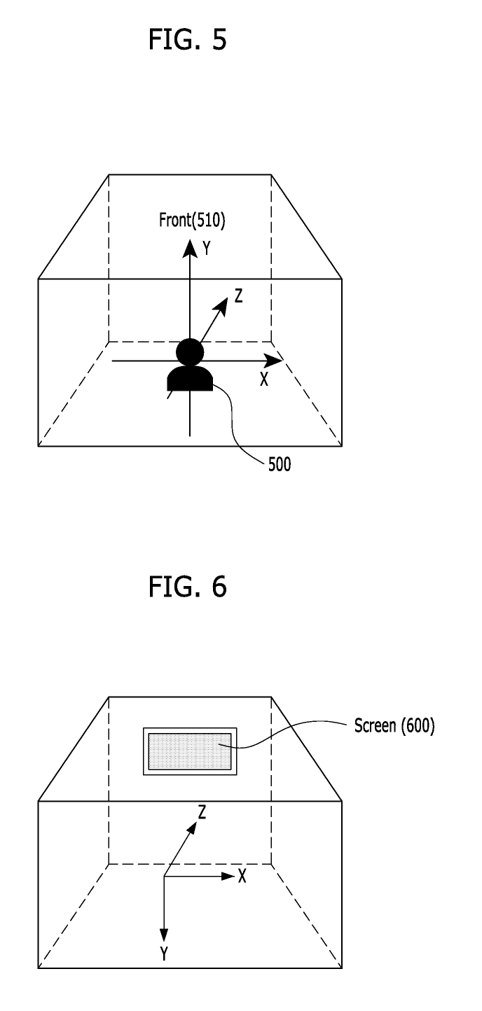

Next, describing the binary representation of the device Cmd, an x, y, and z coordinate system used in the device Cmd represents the positions of the devices, in particular, a front 510 at a predetermined position 500 as illustrated in FIG. 5. FIG. 5 is a diagram schematically illustrating a coordinate system of sensory devices in the system for providing multimedia services in accordance with the exemplary embodiment of the present invention. In addition, as illustrated in FIG. 5, an x axis means a right hand direction of a user, a y axis means a gravity opposite direction, and a z axis means a front direction of a user.

Further, in the device Cmd, the XML representation sytax of the device command base type may be represented as the following Table 12. Table 12 is a table representing the XML representation syntax of the device Cmd base type.

TABLE 12

| | |
|---|---|
| <!-- ################################################ | --> |

| | |
|---|---|
| <!-- Device command base type | --> |

| | |
|---|---|
| <!-- ################################################ | --> |

<complexType name=“DeviceCommandBaseType” abstract=“true”>

<sequence>

<element name=“TimeStamp”

type=“mpegvct:TimeStampType”/>

</sequence>
<attributeGroup ref=“iidl:DeviceCmdBaseAttributes”/>

</complexType>

Further, the binary encoding representation scheme or the binary representation of the syntax represented in Table 12 may be represented as the following Table 13. Herein, Table 13 is a table representing the binary representation syntax.

TABLE 13

| | | Number of | |
|---|---|---|---|
| DeviceCommandBaseType{ | | bits | Mnemonic |
| | TimeStamp | | TimeStampType |
| DeviceCmdBaseAttributes | | | DeviceCmdBaseAttributesType |
| } | | | |
| TimeStampType{ | | | |
| | TimeStampSelect | 2 | bslbf |

if(TimeStampSelect==1){

| | |
|---|---|
| AbsoluteTimeStamp | AbsoluteTimeStampType |

} else if

(TimeStampSelect==2){

| | |
|---|---|
| ClockTickTimeStamp | ClockTickTimeStampType |

} else if

| | |
|---|---|
| (TimeStampSelect==3){ | |
| ClockTickTimeDeltaStamp | ClockTickTimeDeltaStampType |

}

}

In addition, the semantics of the device Cmd base type are as represented in the following Table 14. In this case, Table 14 is a table representing descriptor components semantics.

TABLE 14

| Names | Description |
|---|---|
| TimeStamp | Provides the timing information |
| | for the device command to be |
| | executed. As defined in Part 6 |
| | of ISO/IEC 23005, there is a |
| | choice of selection among three |
| | timing schemes, which are |
| | absolute time, clock tick time, |
| | and delta of clock tick time |
| DeviceCommandBase | Provides the topmost type of |
| | the base type hierarchy which |
| | each individual device command |
| | can inherit. |
| TimeStampType | This field, which is only |
| | present in the binary |
| | representation, describes which |
| | time stamp scheme shall be |
| | used. “1” means that the |
| | absolute time stamp type shall |
| | be used, “2” means that the |
| | clock tick time stamp type |
| | shall be used, and “3” means |
| | that the clock tick time delta |
| | stamp type shall be used. “0” |
| | is reserved. |
| AbsoluteTimeStamp | The absolute time stamp is |
| | defined in A.2.3 of ISO/IEC |
| | 23005-6. |
| ClockTickTimeStamp | The clock tick time stamp is |
| | defined in A.2.3 of ISO/IEC |
| | 23005-6. |
| ClockTickTimeDeltaStamp | The clock tick time delta |
| | stamp, which value is the time |
| | delta between the present and |
| | the past time, is defined in |
| | A.2.3 of ISO/IEC 23005-6. |
| DeviceCmdBaseAttributes | Describes a group of attributes |
| | for the commands. |

In the descriptor component semantics represented in Table 14, the time stamp type may be represented by the binary representation as represented in the following Table 15. That is, in the SEM semantics represented in Table 14, in the descriptor component semantics, the time stamp type is encoded by the binary representation. Herein, Table 15 is a table representing the binary representation of the time stamp type.

TABLE 15

| TimeStampSelect | Type Stamp Type |
|---|---|
| 00 | Forbidden |
| 01 | AbsoluteTimeType |
| 10 | ClockTickTimeType |
| 11 | ClockTickTimeDeltaType |

In addition, the semantics of the device Cmd base type are as represented in the following Table 16 Herein, Table 16 is a table representing the semantics of the device Cmd base type.

TABLE 16

| Name | Description |
|---|---|
| DeviceCommandBaseType | DeviceCommand Base Type. |
| TimeStamp | Element representing time when device |
| | command information is executed. Select |
| | any one of absolute time, clocktick time, |
| | delta of clock tick time. |
| DeviceCmdBaseAttributes | Include common attributes of Device |
| | Command. |

Next, describing device command base attributes, the XML representation syntax of the device command base attributes may be represented as the following Table 17. Herein, Table 17 is a table representing the XML representation syntax of the device command base attributes.

TABLE 17

| <!-- ################################################--> | |
|---|---|
| <!-- Definition of Device Command Base Attributes | --> |

<!-- ################################################-->
<attributeGroup name=“DeviceCmdBaseAttributes”>

<attribute name=“id” type=“ID” use=“optional”/>
<attribute name=“deviceIdRef” type=“anyURI”

use=“optional”/>

<attribute name=“activate” type=“boolean” use=“optional”

default=“true”/>
</attributeGroup>

{Further, the binary encoding representation scheme or the binary representation of the syntax represented in Table 17 may be represented as the following Table 18. Herein, Table 18 is a table representing of the binary representation syntax.

TABLE 18

| | | |
|---|---|---|
| | Number of | |
| DeviceCmdBaseAttributesType{ | bits | Mnemonic |

| | | |
|---|---|---|
| idFlag | 1 | bslbf |
| deviceIdRefFlag | 1 | bslbf |
| activateFlag | 1 | bslbf |
| If(idFlag) { | | |

| | | |
|---|---|---|
| id | See ISO 10646 | UTF-8 |

}
if(deviceIdRefFlag) {

| | |
|---|---|
| deviceIdRef | UTF-8 |

}
if(activateFlag) {

| | | |
|---|---|---|
| activate | 1 | bslbf |

}

}

Further, the binary encoding representation scheme or the binary representation of the syntax represented in Table 17 may be represented as the following Table 19. Herein, Table 19 is a table representing the binary representation syntax.

TABLE 19

| | | Number of | |
|---|---|---|---|
| DeviceCommandBaseType{ | | bits | Mnemonic |
| TimeStampTypeID | | 2 | uimsbf |
| if(TimeStampTypeID==1) { | | | AbsoluteTimeType |
| | absTimeSchemeFlag | 1 | bslbf |
| | if(absTimeSchemeFlag) { | | |

| | |
|---|---|
| absTimeScheme | UTF-8 |

| | |
|---|---|
| } | |
| absTime | UTF-8 |

} else {

| | |
|---|---|
| if (TimeStampTypeID == 2) { | ClockTickTimeType |

| | | |
|---|---|---|
| timeScaleFlag | 1 | bslbf |
| if (timeScaleFlag) { | | |

| | |
|---|---|
| timescale | vluimsbf |

| | |
|---|---|
| } | |
| pts | vluimsbf5 |

| | |
|---|---|
| } else { | ClockTickTimeDeltaType |

| | | |
|---|---|---|
| timeScaleFlag | 1 | bslbf |
| if (timeScaleFlag) { | | |

| | |
|---|---|
| timescale | vluimsbf |

| | |
|---|---|
| } | |
| ptsDelta | vluimsbf5 |

| | } | | |
|---|---|---|---|
| } | | | |
| idFlag | | 1 | bslbf |
| if (idFlag) { | | | |
| | id | | UTF-8 |
| } | | | |
| deviceIdRefFlag | | 1 | bslbf |
| if (deviceIdRefFlag) { | | | |
| | deviceIdRef | | UTF-8 |

| | | |
|---|---|---|
| } | | |
| activateFlag | 1 | bslbf |
| if (activateFlag) { | | |
| activate | 1 | bslbf |
| } | | |
| } | | |

Further, the time stamp type ID of the device command base attributes may be represented as the following Table 20 Herein, Table 20 is a table representing the time stamp type ID.

TABLE 20

| ID | Type Stamp Type |
|---|---|
| 0 | Forbidden |
| 1 | AbsoluteTimeType |
| 2 | ClockTickTimeType |
| 3 | ClockTickTimeDeltaType |

In addition, the semantics of the device command base attributes are as represented in the following Table 21 Descriptor components semantics. Herein, Table 21 is a table representing the descriptor components semantics.

TABLE 21

| Names | Description |
|---|---|
| DeviceCmdBaseAttributesType | Group attributes including |
| | common attributes of Device |
| | Command(Provides the topmost |
| | type of the base type hierarchy |
| | which the attributes of each |
| | individual device command can |
| | inherit). |
| idFlag | This field, which is only |
| | present in the binary |
| | representation, signals the |
| | presence of the id attribute. |
| | A value of “1” means the |
| | attribute shall be used and “0” |
| | means the attribute shall not |
| | be used. |
| deviceIdRefFlag | This field, which is only |
| | present in the binary |
| | representation, signals the |
| | presence of the sensor ID |
| | reference attribute. A value |
| | of “1” means the attribute |
| | shall be used and “0” means the |
| | attribute shall not be used. |
| activateFlag | This field, which is only |
| | present in the binary |
| | representation, signals the |
| | presence of the activation |
| | attribute. A value of “1” means |
| | the attribute shall be used and |
| | “0” means the attribute shall |
| | not be used. |
| id | IDs of each device command(id |
| | to identify the sensed |
| | information with respect to a |
| | light sensor). |
| deviceIdRef | Indicate device linked with |
| | device command(References a |
| | device that has generated the |
| | command included in this |
| | specific device command). |
| activate | Represent operating start or |
| | operation stop of device |
| | (switch off [symbol] ) (Describes |
| | whether the device is |
| | activated. A value of “1” means |
| | the sensor is activated and “0” |
| | means the sensor is |
| | deactivated). |

Next, describing sensed information description tools, a global coordinate for sensors of the sensed information description tools, that is, a xyz coordinate representing the position of the sensor as illustrated in FIG. 6 represents a screen 600 and the xyz coordinate system corresponds to a right hand coordinate system. In this case, FIG. 6 is a diagram schematically illustrating the coordinate system of sensors in the system for providing multimedia services in accordance with an exemplary embodiment of the present invention. As illustrated in FIG. 6, a y axis represents a gravity direction, a z axis represents a front direction of a user, and an x axis represents a right hand direction of a user.

Next, representing the sensed information base type, the syntax of the sensed information base type may be represented as the following table 22. Herein, Table 22 is a table representing the syntax of the sensed information base type.

TABLE 22

| | |
|---|---|
| <!-- ################################################ | --> |

| | |
|---|---|
| <!-- Sensed information base type | --> |

| | |
|---|---|
| <!-- ################################################ | --> |

<complexType name=“SensedInfoBaseType” abstract=“true”>

<sequence>

<element name=“TimeStamp”

type=“mpegvct:TimeStampType”/>

</sequence>
<attributeGroup ref=“iidl:sensedInfoBaseAttributes”/>

</complexType>

Further, the binary encoding representation scheme or the binary representation of the syntax represented in Table 22 may be represented as the following Table 23. Herein, Table 23 is a table representing the binary representation syntax.

TABLE 23

| | | |
|---|---|---|
| | Number of | |
| SensedInfoBaseType{ | bits | Mnemonic |

TimeStampTypeID•2uimsbf
2uimsbf
* Table 3 [symbol]
if(TimeStampTypeID==1) {

| | | |
|---|---|---|
| absTimeSchemeFlag | 1 | bslbf |
| if(absTimeSchemeFlag) { | | |

| | |
|---|---|
| absTimeScheme | UTF-8 |

| | |
|---|---|
| } | |
| absTime | UTF-8 |

} else {

| | |
|---|---|
| if (TimeStampTypeID == 2) | ClockTickTimeType |

{

| | | |
|---|---|---|
| timeScaleFlag | 1 | bslbf |
| if (timeScaleFlag) { | | |

| | |
|---|---|
| timescale | vluimsbf |

| | |
|---|---|
| } | |
| pts | vluimsbf5 |

| | |
|---|---|
| } else { | ClockTickTimeDeltaType |

| | | |
|---|---|---|
| timeScaleFlag | 1 | bslbf |
| if (timeScaleFlag) { | | |

| | |
|---|---|
| timescale | vluimsbf |

| | |
|---|---|
| } | |
| ptsDelta | vluimsbf5 |

| | } | | |
|---|---|---|---|
| } | | | |
| idFlag | | 1 | bslbf |
| if (idFlag) { | | | |
| | id | | UTF-8 |
| } | | | |
| sensorIdRefFlag | | 1 | bslbf |
| if (sensorIdRefFlag) { | | | |
| | sensorIdRef | | UTF-8 |
| } | | | |
| linkedlistFlag | | 1 | bslbf |
| if (linkedlistFlag) { | | | |
| | linkedlist | | UTF-8 |

| } | | | |
|---|---|---|---|
| groupIDFlag | | 1 | bslbf |
| if (groupIDFlag) { | | | |
| | groupID | | UTF-8 |
| } | | | |
| activateFlag | | 1 | bslbf |
| if (activateFlag) { | | | |
| | activate | 1 | bslbf |
| } | | | |
| priorityFlag | | 1 | bslbf |
| if (priorityFlag) { | | | |
| | priority | 1 | vluimsbf |

}
}

In addition, the semantics of the sensed information base type are as represented in the following Table 24. Herein, Table 24 is a table representing the syntax of the sensed information base type.

TABLE 24

| Name | Description |
|---|---|
| SensedInfoBaseType | Type of SensedInfo node |
| SensedInfoBaseAttributes | Group attributes including common |
| | attritbutes of sensed information. |
| TimeStamp | Element including time information of |
| | Sensed information. Select one of absolute |
| | time, clocktick time, delta of clock tick |
| | time. |

Next, describing the sensed information base attributes, the syntax of the sensed information base attributes may be represented as the following table 25. Herein, Table 25 is a table representing the syntax of the sensed information base attributes.

TABLE 25
<!-- ################################################### -->

| | |
|---|---|
| <!-- Definition of Sensed information Base Attributes | --> |

<!-- ################################################### -->
<attributeGroup name=“SensedInfoBaseAttributes”>

<attribute name=“id” type=“ID” use=“optional”/>
<attribute name=“sensorIdRef” type=“anyURI”

use=“optional”/>

<attribute name=“linkedlist” type=“anyURI”

use=“optional”/>

<attribute name=“groupID” type=“anyURI” use=“optional”/>
<attribute name=“activate” type=“boolean” use=“optional”/>
<attribute name=“priority” type=“nonNegativeInteger”

use=“optional” default=“0”/>
</attributeGroup>

In addition, the semantics of the sensed information base attributes are as represented in the following Table 26. Herein, Table 26 is a table representing the semantics of the sensed information base attributes.

TABLE 26

| Name | Description |
|---|---|
| SensedInfoBaseAttributes | Attribute group including common |
| | attributes of Sensed Information. |
| Id | ID for each sensed information |
| sensorIdRef | ID of sensor acquired by sensed |
| | information. |
| linkedlist | Include sensor group configured of at |
| | least one sensor. |
| groupID | ID differentiating group of multi sensors. |
| activate | Attributes representing operation or stop |
| | of sensor |
| priority | Attributes for representing priority among |
| | at least sensed information when at least |
| | one sensed information is input. |

Hereinafter, the encoding of command information for the device command of the user devices using the binary representation will be described in more detail. As described above, the various sensory effects of the multimedia contents may be, for example, a light effect, a colored light effect, a flash light effect, a temperature effect, a wind effect, a vibration effect, a water sprayer effect as a spraying effect, a scent effect, a fog effect, a color correction effect, a motion and feeling effect (for example, rigid body motion effect), a passive kinesthetic motion effect, a passive kinesthetic force effect, an active kinesthetic effect, a tactile effect, or the like, all of which are provided to the users by the device command of each user device. That is, the user server 130 encodes the command information by the binary representation so as to simultaneously provide the sensory effects and the multimedia contents in real time and the user server, in particular, the encoder 3 340 defines the syntax, the binary representation, and the semantics of the sensory effects for each sensory effects.

First, describing a device command vocabulary, in the type of the device command term, the XML representation syntax of a light type may be represented as the following Table 27. Herein, Table 27 is a table representing the XML representation syntax of the light type.

TABLE 27

| <!-- ################################################ --> | |
|---|---|
| <!-- Definition of DCV Light Type | --> |

<!-- ################################################ -->
<complexType name=“LightType”>

<complexContent>

<extension base=“iidl:DeviceCommandBaseType”>

<attribute name=“color”

type=“mpegvct:colorType” use=“optional”/>

<attribute name=“intensity” type=“integer”

use=“optional”/>

</extension>

</complexContent>

</complexType>

Further, the binary encoding representation scheme or the binary representation of the syntax represented in Table 27 may be represented as the following Table 28. Herein, Table 28 is a table representing the binary representation syntax.

TABLE 28

| LightType{Number | | | |
|---|---|---|---|
| of bits | | Mnemonic | |
| | colorFlag | 1 | bslbf |
| | intensityFlag | 1 | bslbf |
| | DeviceCommandBase | | DeviceCommandBaseType |
| | if(colorFlag) { | | |

| | |
|---|---|
| color | colorType |

}
if(intensityFlag) {

| | | |
|---|---|---|
| intensity | 7 | uimsbf |

}

}

In the binary representation of the light type represented in Table 28, the binary encoding representation scheme or the binary representation of the color may be represented as the following Table 29. Herein, Table 29 is a table representing the binary representation syntax.

TABLE 29

| | | |
|---|---|---|
| | Number of | |
| colorType { | bits | Mnemonic |

| | |
|---|---|
| NamedcolorFlag | 1 |

If(namedcolorFlag) {

| | | |
|---|---|---|
| NamedColorType | 9 | bslbf |
| } else { | | |
| RGBType | 56 | Bslbf |
| } | | |
| } | | |

In addition, the semantics of the light type are represented as the following Table 30. Herein, Table 30 is a table representing the descriptor components semantics of the light type.

TABLE 30

| Name | Description |
|---|---|
| LightType | Type including light device command |
| | information(Tool for describing a command |
| | for a lighting device to follow). |
| colorFlag | This field, which is only present in the |
| | binary representation, signals the |
| | presence of color attribute. A value of |
| | “1” means the attribute shall be used and |
| | “0” means the attribute shall not be used. |
| intensityFlag | This field, which is only present in the |
| | binary representation, signals the |
| | presence of device command attribute. A |
| | value of “1” means the attribute shall be |
| | used and “0” means the attribute shall not |
| | be used. |
| DeviceCommandBase | Provides the topmost type of the base type |
| | hierarchy which each individual device |
| | command can inherit. |
| NamedcolorFlag | This field, which is only present in the |
| | binary representation, indicates a choice |
| | of the color descriptions. If it is 1 then |
| | the color is described by |
| | mpeg7:termReferenceType, otherwise the |
| | color is described by colorRGBType. |
| NamedColorType | This field, which is only present in the |
| | binary representation, describes color in |
| | terms of ColorCS Flag in Annex A.2.1. |
| colorRGBType | This field, which is only present in the |
| | binary representation, describes color in |
| | terms of colorRGBType. |
| Intensity | Represent output intensity of light device |
| | (Describes the intensity that the lighting |
| | device shall emit in percentage with |
| | respect to the maximum intensity that the |
| | specific device can generate). |
| color | Indicate color of light. Indicated by |
| | classification scheme(CS) or RGB value. CS |
| | refers to A.2.2 of ISO/IEC 23005-6 |
| | (Describes the list of colors which the |
| | lighting device can sense as a reference |
| | to a classification scheme term or as RGB |
| | value. A CS that may be used for this |
| | purpose is the ColorCS defined in A.2.3 of |
| | ISO/IEC 23005-6 and use the binary |
| | representation defined above.). |

Further, in the light type semantics represented in Table 30, a color may be represented by the binary representation as represented in the following Table 31. That is, in the light type semantics represented in Table 30, the color is encoded by the binary representation. Herein, Table 31 is a table representing the binary representation of color, that is, a named color type.

TABLE 31

| NamedcolorType | Term ID of color |
|---|---|
| 000000000 | alice_blue |
| 000000001 | alizarin |
| 000000010 | amaranth |
| 000000011 | amaranth_pink |
| 000000100 | amber |
| 000000101 | amethyst |
| 000000110 | apricot |
| 000000111 | aqua |
| 000001000 | aquamarine |
| 000001001 | army_green |
| 000001010 | asparagus |
| 000001011 | atomic_tangerine |
| 000001100 | auburn |
| 000001101 | azure_color_wheel |
| 000001110 | azure_web |
| 000001111 | baby_blue |
| 000010000 | beige |
| 000010001 | bistre |
| 000010010 | black |
| 000010011 | blue |
| 000010100 | blue_pigment |
| 000010101 | blue_ryb |
| 000010110 | blue_green |
| 000010111 | blue-green |
| 000011000 | blue-violet |
| 000011001 | bondi_blue |
| 000011010 | brass |
| 000011011 | bright_green |
| 000011100 | bright_pink |
| 000011101 | bright_turquoise |
| 000011110 | brilliant_rose |
| 000011111 | brink_pink |
| 000100000 | bronze |
| 000100001 | brown |
| 000100010 | buff |
| 000100011 | burgundy |
| 000100100 | burnt_orange |
| 000100101 | burnt_sienna |
| 000100110 | burnt_umber |
| 000100111 | camouflage_green |
| 000101000 | caput_mortuum |
| 000101001 | cardinal |
| 000101010 | carmine |
| 000101011 | carmine_pink |
| 000101100 | carnation_pink |
| 000101101 | Carolina_blue |
| 000101110 | carrot_orange |
| 000101111 | celadon |
| 000110000 | cerise |
| 000110001 | cerise_pink |
| 000110010 | cerulean |
| 000110011 | cerulean_blue |
| 000110100 | champagne |
| 000110101 | charcoal |
| 000110110 | chartreuse_traditional |
| 000110111 | chartreuse_web |
| 000111000 | cherry_blossom_pink |
| 000111001 | chestnut |
| 000111010 | chocolate |
| 000111011 | cinnabar |
| 000111100 | cinnamon |
| 000111101 | cobalt |
| 000111110 | Columbia_blue |
| 000111111 | copper |
| 001000000 | copper_rose |
| 001000001 | coral |
| 001000010 | coral_pink |
| 001000011 | coral_red |
| 001000100 | corn |
| 001000101 | cornflower_blue |
| 001000110 | cosmic_latte |
| 001000111 | cream |
| 001001000 | crimson |
| 001001001 | cyan |
| 001001010 | cyan_process |
| 001001011 | dark_blue |
| 001001100 | dark_brown |
| 001001101 | dark_cerulean |
| 001001110 | dark_chestnut |
| 001001111 | dark_coral |
| 001010000 | dark_goldenrod |
| 001010001 | dark_green |
| 001010010 | dark_khaki |
| 001010011 | dark_magenta |
| 001010100 | dark_pastel_green |
| 001010101 | dark_pink |
| 001010110 | dark_scarlet |
| 001010111 | dark_salmon |
| 001011000 | dark_slate_gray |
| 001011001 | dark_spring_green |
| 001011010 | dark_tan |
| 001011011 | dark_turquoise |
| 001011100 | dark_violet |
| 001011101 | deep_carmine_pink |
| 001011110 | deep_cerise |
| 001011111 | deep_chestnut |
| 001100000 | deep_fuchsia |
| 001100001 | deep_lilac |
| 001100010 | deep_magenta |
| 001100011 | deep_magenta |
| 001100100 | deep_peach |
| 001100101 | deep_pink |
| 001100110 | denim |
| 001100111 | dodger_blue |
| 001101000 | ecru |
| 001101001 | egyptian_blue |
| 001101010 | electric_blue |
| 001101011 | electric_green |
| 001101100 | elctric_indigo |
| 001101101 | electric_lime |
| 001101110 | electric_purple |
| 001101111 | emerald |
| 001110000 | eggplant |
| 001110001 | falu_red |
| 001110010 | fern_green |
| 001110011 | firebrick |
| 001110100 | flax |
| 001110101 | forest_green |
| 001110110 | french_rose |
| 001110111 | fuchsia |
| 001111000 | fuchsia_pink |
| 001111001 | gamboge |
| 001111010 | gold_metallic |
| 001111011 | gold_web_golden |
| 001111100 | golden_brown |
| 001111101 | golden_yellow |
| 001111110 | goldenrod |
| 001111111 | grey-asparagus |
| 010000000 | green_color_wheel_x11_green |
| 010000001 | green_html/css_green |
| 010000010 | green_pigment |
| 010000011 | green_ryb |
| 010000100 | green_yellow |
| 010000101 | grey |
| 010000110 | han_purple |
| 010000111 | harlequin |
| 010001000 | heliotrope |
| 010001001 | Hollywood_cerise |
| 010001010 | hot_magenta |
| 010001011 | hot_pink |
| 010001100 | indigo_dye |
| 010001101 | international_klein_blue |
| 010001110 | international_orange |
| 010001111 | Islamic_green |
| 010010000 | ivory |
| 010010001 | jade |
| 010010010 | kelly_green |
| 010010011 | khaki |
| 010010100 | khaki_x11_light_khaki |
| 010010101 | lavender_floral |
| 010010110 | lavender_web |
| 010010111 | lavender_blue |
| 010011000 | lavender_blush |
| 010011001 | lavender_grey |
| 010011010 | lavender_magenta |
| 010011011 | lavender_pink |
| 010011100 | lavender_purple |
| 010011101 | lavender_rose |
| 010011110 | lawn_green |
| 010011111 | lemon |
| 010100000 | lemon_chiffon |
| 010100001 | light_blue |
| 010100010 | light_pink |
| 010100011 | lilac |
| 010100100 | lime_color_wheel |
| 010100101 | lime_web_x11_green |
| 010100110 | lime_green |
| 010100111 | linen |
| 010101000 | magenta |
| 010101001 | magenta_dye |
| 010101010 | magenta_process |
| 010101011 | magic_mint |
| 010101100 | magnolia |
| 010101101 | malachite |
| 010101110 | maroon_html/css |
| 010101111 | marron_x11 |
| 010110000 | maya_blue |
| 010110001 | mauve |
| 010110010 | mauve_taupe |
| 010110011 | medium_blue |
| 010110100 | medium_carmine |
| 010110101 | medium_lavender_magenta |
| 010110110 | medum_purple |
| 010110111 | medium_spring_green |
| 010111000 | midnight_blue |
| 010111001 | midnight_green_eagle_green |
| 010111010 | mint_green |
| 010111011 | misty_rose |
| 010111100 | moss_green |
| 010111101 | mountbatten_pink |
| 010111110 | mustard |
| 010111111 | myrtle |
| 011000000 | navajo_white |
| 011000001 | navy_blue |
| 011000010 | ochre |
| 011000011 | office_green |
| 011000100 | old_gold |
| 011000101 | old_lace |
| 011000110 | old_lavender |
| 011000111 | old_rose |
| 011001000 | olive |
| 011001001 | olive_drab |
| 011001010 | olivine |
| 011001011 | orange_color_wheel |
| 011001100 | orange_ryb |
| 011001101 | orange_web |
| 011001110 | orange_peel |
| 011001111 | orange-red |
| 011010000 | orchid |
| 011010001 | pale_blue |
| 011010010 | pale_brown |
| 011010011 | pale_carmine |
| 011010100 | pale_chestnut |
| 011010101 | pale_cornflower_blue |
| 011010110 | pale_magenta |
| 011010111 | pale_pink |
| 011011000 | pale_red-violet |
| 011011001 | papaya_whip |
| 011011010 | pastel_green |
| 011011011 | pastel_pink |
| 011011100 | peach |
| 011011101 | peach-orange |
| 011011110 | peach-yellow |
| 011011111 | pear |
| 011100000 | periwinkle |
| 011100001 | persian_blue |
| 011100010 | persian_green |
| 011100011 | persian_indigo |
| 011100100 | persian_orange |
| 011100101 | persian_red |
| 011100110 | persian_pink |
| 011100111 | persian_rose |
| 011101000 | persimmon |
| 011101001 | pine_green |
| 011101010 | pink |
| 011101011 | pink-orange |
| 011101100 | platinum |
| 011101101 | plum_web |
| 011101110 | powder_blue_web |
| 011101111 | puce |
| 011110000 | prussian_blue |
| 011110001 | psychedelic_purple |
| 011110010 | pumpkin |
| 011110011 | purple_html/css |
| 011110100 | purple_x11 |
| 011110101 | purple_taupe |
| 011110110 | raw_umber |
| 011110111 | razzmatazz |
| 011111000 | red |
| 011111001 | red_pigment |
| 011111010 | red_ryb |
| 011111011 | red-violet |
| 011111100 | rich_carmine |
| 011111101 | robin_egg_blue |
| 011111110 | rose |
| 011111111 | rose_madder |
| 100000000 | rose_taupe |
| 100000001 | royal_blue |
| 100000010 | royal_purple |
| 100000011 | ruby |
| 100000100 | russet |
| 100000101 | rust |
| 100000110 | safety_orange_blaze_orange |
| 100000111 | saffron |
| 100001000 | salmon |
| 100001001 | sandy_brown |
| 100001010 | sangria |
| 100001011 | sapphire |
| 100001100 | scarlet |
| 100001101 | school_bus_yellow |
| 100001110 | sea_green |
| 100001111 | seashell |
| 100010000 | selective_yellow |
| 100010001 | sepia |
| 100010010 | shamrock_green |
| 100010011 | shocking_pink |
| 100010100 | silver |
| 100010101 | sky_blue |
| 100010110 | slate_grey |
| 100010111 | smalt_dark_powder_blue |
| 100011000 | spring_bud |
| 100011001 | spring_green |
| 100011010 | steel_blue |
| 100011011 | tan |
| 100011100 | tangerine |
| 100011101 | tangerine_yellow |
| 100011110 | taupe |
| 100011111 | tea_green |
| 100100000 | tea_rose_orange |
| 100100001 | tea_rose_rose |
| 100100010 | teal |
| 100100011 | tenne_tawny |
| 100100100 | terra_cotta |
| 100100101 | thistle |
| 100100110 | tomato |
| 100100111 | turquoise |
| 100101000 | tyrian_purple |
| 100101001 | ultramarine |
| 100101010 | ultra_pink |
| 100101011 | united_nation_blue |
| 100101100 | vegas_gold |
| 100101101 | vermilion |
| 100101110 | violet |
| 100101111 | violet_web |
| 100110000 | violet_ryb |
| 100110001 | viridian |
| 100110010 | wheat |
| 100110011 | white |
| 100110100 | wisteria |
| 100110101 | yellow |
| 100110110 | yellow_process |
| 100110111 | yellow_ryb |
| 100111000 | yellow_green |
| 100111001-111111111 | Reserved |

Next, the XML representation syntax of a flash type may be represented as the following Table 32. Herein, Table 32 is a table representing the XML representation syntax of the flash type.

TABLE 32

| <!-- ################################################ --> | |
|---|---|
| <!-- Definition of DCV Flash Type | --> |

<!-- ################################################ -->
<complexType name=“FlashType”>

<complexContent>

<extension base=“dcv:LightType”>

<attribute name=“frequency”

type=“positiveInteger” use=“optional”/>

</extension>

</complexContent>

</complexType>

Further, the binary encoding representation scheme or the binary representation of the syntax represented in Table 32 may be represented as the following Table 33. Herein, Table 33 is a table representing the binary representation syntax.

TABLE 33

FlashType{(Number
of bits)(Mnemonic)

| | | |
|---|---|---|
| frequencyFlag | 1 | bslbf |
| Light | | LightType |
| if(frequencyFlag) { | | |
| frequency | 5 | uimsbf |

}

}

In addition, the semantics of the flash type are represented as the following Table 34. Herein, Table 34 is a table representing the descriptor components semantics of the flash type.

TABLE 34

| Name | Description |
|---|---|
| FlashType | Type representing Flash device command |
| | information (Tool for describing a flash |
| | device command). |
| requencyFlag | This field, which is only present in the |
| | binary representation, signals the |
| | presence of color attribute. A value of |
| | “1” means the attribute shall be used and |
| | “0” means the attribute shall not be used. |
| Light | Describes a command for a lighting device. |
| Frequency | Represent flickering period of Flash |
| | device (Describes the number of flickering |
| | in percentage with respect to the maximum |
| | frequency that the specific flash device |
| | can generate). |

Next, the XML representation syntax of a heating type may be represented as the following Table 35. Herein, Table 35 is a table representing the XML representation syntax of the heating type.

TABLE 35

| <!-- ################################################ --> | |
|---|---|
| <!-- Definition of DCV Heating Type | --> |

<!-- ################################################ -->
<complexType name=“HeatingType”>

<complexContent>

<extension base=“iidl:DeviceCommandBaseType”>

<attribute name=“intensity” type=“integer”

use=“optional”/>

</extension>

</complexContent>

</complexType>

Further, the binary encoding representation scheme or the binary representation of the syntax represented in Table 35 may be represented as the following Table 36. Herein, Table 36 is a table representing the binary representation syntax.

TABLE 36

| | | (Number of | |
|---|---|---|---|
| HeatingType{ | | bits) | (Mnemonic) |
| | intensityFlag | 1 | bslbf |
| | DeviceCommandBase | | DeviceCommandBaseType |
| | if(intensityFlag) { | | |

| | | |
|---|---|---|
| intensity | 7 | uimsbf |

}

}

In addition, the semantics of the heating type are represented as the following Table 37. Herein, Table is a table representing the descriptor components semantics of the heating type.

TABLE 37

| Name | Description |
|---|---|
| HeatingType | Type representing heater command |
| | information (Tool for describing a command |
| | for heating device). |
| intensityFlag | This field, which is only present in the |
| | binary representation, signals the |
| | presence of device command attribute. A |
| | value of “1” means the attribute shall be |
| | used and “0” means the attribute shall not |
| | be used |
| DeviceCommandBase | Provides the topmost type of the base type |
| | hierarchy which each individual device |
| | command can inherit. |
| Intensity | Represent output from heater. Basically |
| | represented by Celsius (Describes the |
| | intensity that the heating device shall |
| | emit in percentage with respect to the |
| | maximum intensity that the specific device |
| | can generate). |

Next, the XML representation syntax of a cooling type may be represented as the following Table 38. Herein, Table 38 is a table representing the XML representation syntax of the cooling type.

TABLE 38

| <!-- ################################################ --> | |
|---|---|
| <!-- Definition of DCV Cooling Type | --> |

<!-- ################################################ -->
<complexType name=“CoolingType”>

<complexContent>

<extension base=“iidl:DeviceCommandBaseType”>

<attribute name=“intensity” type=“integer”

use=“optional”/>

</extension>

</complexContent>

</complexType>

Further, the binary encoding representation scheme or the binary representation of the syntax represented in Table 38 may be represented as the following Table 39. Herein, Table 39 is a table representing the binary representation syntax.

TABLE 39

| | | Number of | |
|---|---|---|---|
| CoolingType{ | | bits | Mnemonic |
| | intensityFlag | 1 | bslbf |
| | DeviceCommandBase | | DeviceCommandBaseType |
| | if(intensityFlag) { | | |

| | | |
|---|---|---|
| intensity | 7 | uimsbf |

}

}

In addition, the semantics of the cooling type are represented as the following Table 40. Herein, Table is a table representing the descriptor components semantics of the cooling type.

TABLE 40

| Name | Description |
|---|---|
| CoolingType | Type representing cooling device command |
| | information (Tool for describing a command |
| | for cooling device). |
| intensityFlag | This field, which is only present in the |
| | binary representation, signals the |
| | presence of device command attribute. A |
| | value of “1” means the attribute shall be |
| | used and “0” means the attribute shall not |
| | be used |
| DeviceCommandBase | Provides the topmost type of the base type |
| | hierarchy which each individual device |
| | command can inherit |
| Intensity | |
| Represent output of | |
| cooling devie. | |
| Basically represnted | |
| by Celisus | |
| (Describes the | |
| intensity that the | |
| cooling device shall | |
| emit in percentage | |
| with respect to the | |
| maximum intensity | |
| that the specific | |
| device can | |
| generate). | |

Next, the XML representation syntax of a wind type may be represented as the following Table 41. Herein, Table 41 is a table representing the XML representation syntax of the wind type.

TABLE 41

| <!-- ################################################ --> | |
|---|---|
| <!-- Definition of DCV Wind Type | --> |

<!-- ################################################ -->
<complexType name=“WindType”>

<complexContent>

<extension base=“iidl:DeviceCommandBaseType”>

<attribute name=“intensity” type=“integer”

use=“optional”/>

</extension>

</complexContent>

</complexType>

Further, the binary encoding representation scheme or the binary representation of the syntax represented in Table 41 may be represented as the following Table 42. Herein, Table 42 is a table representing the binary representation syntax.

[symbol]

42

| | | Number of | |
|---|---|---|---|
| WindType{ | | bits | Mnemonic |
| | intensityFlag | 1 | bslbf |
| | DeviceCommandBase | | DeviceCommandBaseType |
| | if(intensityFlag) { | | |

| | | |
|---|---|---|
| intensity | 7 | uimsbf |

}

}

In addition, the semantics of the wind type are represented as the following Table 43. Herein, Table 43 is a table representing the descriptor components semantics of the wind type.

TABLE 43

| Name | Description |
|---|---|
| WindType | Type representing command information of |
| | wind device (Tool for describing a wind |
| | device command). |
| intensityFlag | This field, which is only present in the |
| | binary representation, signals the |
| | presence of device command attribute. A |
| | value of “1” means the attribute shall be |
| | used and “0” means the attribute shall not |
| | be used. |
| DeviceCommandBase | Provides the topmost type of the base type |
| | hierarchy which each individual device |
| | command can inherit |
| Intensity | Represent output intensity of mps unit |
| | (Describes the intensity of the wind |
| | effect in terms of strength in percentage |
| | with respect to the maximum intensity of |
| | the specified device. If the intensity is |
| | not specified, this command shall be |
| | interpreted as turning on at the maximum |
| | intensity). |

Next, the XML representation syntax of a vibration type may be represented as the following Table 44. Herein, Table 44 is a table representing the XML representation syntax of the vibration type.

TABLE 44

| <!-- ################################################ --> | |
|---|---|
| <!-- Definition of DCV Vibration Type | --> |

<!-- ################################################ -->
<complexType name=“VibrationType”>

<complexContent>

<extension base=“iidl:DeviceCommandBaseType”>

<attribute name=“intensity” type=“integer”

use=“optional”/>

</extension>

</complexContent>

</complexType>

Further, the binary encoding representation scheme or the binary representation of the syntax represented in Table 44 may be represented as the following Table 45. Herein, Table 45 is a table representing the binary representation syntax.

TABLE 45

| | | Number of | |
|---|---|---|---|
| VibrationType{ | | bits | Mnemonic |
| | intensityFlag | 1 | bslbf |
| | DeviceCommandBase | | DeviceCommandBaseType |
| | if(intensityFlag) { | | |

| | | |
|---|---|---|
| intensity | 7 | uimsbf |

}

}

In addition, the semantics of the vibration type are represented as the following Table 46. Herein, Table 46 is a table representing the descriptor components semantics of the vibration type.

TABLE 46

| Name | Description |
|---|---|
| VibrationType | Type representing command information of |
| | vibration device (Tool for describing a |
| | vibration device command). |
| intensityFlag | This field, which is only present in the |
| | binary representation, signals the |
| | presence of device command attribute. A |
| | value of “1” means the attribute shall be |
| | used and “0” means the attribute shall not |
| | be use. |
| DeviceCommandBase | Provides the topmost type of the base type |
| | hierarchy which each individual device |
| | command can inherit |
| intensity | Describe output intensity of vibration |
| | device Richter scale unit (Describes the |
| | intensity of the vibration effect in terms |
| | of strength in percentage with respect to |
| | the maximum intensity of the specified |
| | device. If the intensity is not specified, |
| | this command shall be interpreted as |
| | turning on at the maximum intensity). |

Next, the XML representation syntax of a sprayer type may be represented as the following Table 47. Herein, Table 47 is a table representing the XML representation syntax of the sprayer type.

TABLE 47

| <!-- ################################################ --> | |
|---|---|
| <!-- Definition of DCV Sprayer Type | --> |

<!-- ################################################ -->
<complexType name=“SprayerType”>

<complexContent>

<extension base=“iidl:DeviceCommandBaseType”>

<attribute name=“sprayingType”

type=“mpeg7:termReferenceType”/>

<attribute name=“intensity” type=“integer”

use=“optional”/>

</extension>

</complexContent>

</complexType>

Further, the binary encoding representation scheme or the binary representation of the syntax represented in Table 47 may be represented as the following Table 48. Herein, Table 48 is a table representing the binary representation syntax.

TABLE 48

| | Number | |
|---|---|---|
| SprayerType{ | of bits | Mnemonic |
| sprayingFlag | 1 | bslbf |
| intensityFlag | 1 | bslbf |
| DeviceCommandBase | | DeviceCommandBaseType |
| if(sprayingFlag) { | | |
| spraying | | SprayingType |
| } | | |
| if(intensityFlag) { | | |
| intensity | 7 | Uimsbf |
| } | | |
| } | | |

In addition, the semantics of the sprayer type are represented as the following Table 49. Herein, Table 49 is a table representing the descriptor components semantics of the sprayer type.

TABLE 49

| Name | Description |
|---|---|
| SprayerType | Type representing commmand information of |
| | spray device (Tool for describing a liquid |
| | spraying device command). |
| sprayingFlag | This field, which is only present in the |
| | binary representation, signals the |
| | presence of device command attribute. A |
| | value of “1” means the attribute shall be |
| | used and “0” means the attribute shall not |
| | be used |
| intensityFlag | This field, which is only present in the |
| | binary representation, signals the |
| | presence of device command attribute. A |
| | value of “1” means the attribute shall be |
| | used and “0” means the attribute shall not |
| | be used |
| DeviceCommandBase | Provides the topmost type of the base type |
| | hierarchy which each individual device |
| | command can inherit. |
| sprayingType | Describe spraying effect type using |
| | classification scheme (Describes the type |
| | of the sprayed material as a reference to |
| | a classification scheme term. A CS that |
| | may be used for this purpose is the |
| | SprayingTypeCS defined in Annex A.2.7 of |
| | ISO/IEC 23005-6). |
| Intensity | Represent output intensity of spray device |
| | in m1/h unit (Describes the intensity that |
| | the liquid is sprayed in percentage with |
| | respect to the maximum intensity described |
| | in the device capability. If the intensity |
| | is not specified, this command shall be |
| | interpreted as turning on at the maximum |
| | intensity). |

the descriptor component semantics of the sprayer type represented in Table 49, the spraying type may be represented by the binary representation as represented in the Table 50. That is, in the descriptor component semantics of the sprayer type represented in Table 49, the spraying type is represented by the binary representation. Herein, Table 50 is a table representing the binary representation of the spraying type.

TABLE 50

| SprayingID | spraying type |
|---|---|
| 00000000 | Reserved |
| 00000001 | Purified Water |
| 00000010~11111111 | Reserved |

Further, the spraying type ID is represented as Table 51. Herein, Table 51 is a table representing the spraying type ID.

TABLE 51

| ID | Spraying Type |
|---|---|
| 0 | Forbidden |
| 1 | Purified Water |
| 2~255 | Reserved |

Next, the XML representation syntax of a scent type may be represented as the following Table 52. Herein, Table 52 is a table representing the XML representation syntax of the scent type.

```
TABLE 52
<!-- ################################################ -->
<!--  Definition of DCV Scent Type  -->
<!-- ################################################ -->
<complexType name=“ScentType”>
    <complexContent>
        <extension base=“iidl:DeviceCommandBaseType”>
                <attribute  name=“scent”
type=“mpeg7:termReferenceType” use=“optional”/>
                <attribute  name=“intensity”  type=“integer”
use=“optional”/>
        </extension>
    </complexContent>
</complexType>
```

Further, the binary encoding representation scheme or the binary representation of the syntax represented in Table 52 may be represented as the following Table 53. Herein, Table 53 is a table representing the binary representation syntax.

TABLE 53

| | Number | |
|---|---|---|
| ScentType{ | of bits | Mnemonic |
| scentFlag | 1 | bslbf |
| intensityFlag | 1 | bslbf |
| DeviceCommandBase | | DeviceCommandBaseType |
| if(scentFlag) { | | |
| scent | | ScentCSType |
| } | | |
| if(intensityFlag) { | | |
| intensity | 7 | uimsbf |
| } | | |
| } | | |

In addition, the semantics of the scent type are represented as the following Table 54. Herein, Table 54 is a table representing the descriptor components semantics of the scent type.

TABLE 54

| Name | Description |
|---|---|
| ScentType | Type representing command information of a |
| | scent device (Tool for describing a scent |
| | device command). |
| scentFlag | This field, which is only present in the |
| | binary representation, signals the |
| | presence of device command attribute. A |
| | value of “1” means the attribute shall be |
| | used and “0” means the attribute shall not |
| | be used |
| intensityFlag | This field, which is only present in the |
| | binary representation, signals the |
| | presence of device command attribute. A |
| | value of “1” means the attribute shall be |
| | used and “0” means the attribute shall not |
| | be used |
| DeviceCommandBase | Provides the topmost type of the base type |
| | hierarchy which each individual device |
| | command can inherit |
| Intensity | Represent output intensity of direction |
| | device in m1/h unit (Describes the |
| | intensity of the scent effect in |
| | percentage with respect to the maximum |
| | intensity described in the device |
| | capability. If the intensity is not |
| | specified, this command shall be |
| | interpreted as turning on at the maximum |
| | intensity). |
| Scent | Describe scent type using classification |
| | scheme (Provides the topmost type of the |
| | base type hierarchy which each individual |
| | device command can inherit). |

In the descriptor component semantics of the scent type represented in Table 54, the scent may be represented by the binary representation as represented in the Table 55. That is, in the descriptor component semantics of the scent type represented in Table 54, the scent is represented by the binary representation. Herein, Table 55 is a table representing the binary representation of the scent

TABLE 55

| Scent | Semantics |
|---|---|
| 00000000 | Reserved |
| 00000001 | rose |
| 00000010 | acacia |
| 00000011 | chrysanthemum |
| 00000100 | lilac |
| 00000101 | mint |
| 00000110 | jasmine |
| 00000111 | pine tree |
| 00001000 | orange |
| 00001001 | grape |
| 00001010~11111111 | Reserved |

Next, the XML representation syntax of a fog type may be represented as the following Table 56. Herein, Table 56 is a table representing the XML representation syntax of the fog type.

```
TABLE 56
<!-- ################################################ -->
<!--  Definition of DCV Fog Type  -->
<!-- ################################################ -->
<complexType name=“FogType”>
    <complexContent>
            <extension base=“iidl:DeviceCommandBaseType”>
                <attribute  name=“intensity”  type=“integer”
use=“optional”/>
            </extension>
    </complexContent>
</complexType>
```

Further, the binary encoding representation scheme or the binary representation of the syntax represented in Table 56 may be represented as the following Table 57. Herein, Table 57 is a table representing the binary representation syntax.

TABLE 57

| | Number | |
|---|---|---|
| FogType{ | of bits | Mnemonic |
| intensityFlag | 1 | bslbf |
| DeviceCommandBase | | DeviceCommandBaseType |
| if(intensityFlag) { | | |
| intensity | 7 | uimsbf |
| } | | |
| } | | |

In addition, the semantics of the fog type are represented as the following Table 58. Herein, Table 58 is a table representing the descriptor components semantics of the fog type.

TABLE 58

| Name | Description |
|---|---|
| FogType | Type describing command information of fog |
| | device (Tool for describing a fog device |
| | command). |
| intensityFlag | This field, which is only present in the |
| | binary representation, signals the |
| | presence of device command attribute. A |
| | value of “1” means the attribute shall be |
| | used and “0” means the attribute shall not |
| | be used. |
| DeviceCommandBase | Provides the topmost type of the base type |
| | hierarchy which each individual device |
| | command can inherit. |
| Intensity | Describe output intensity of fog device in |
| | ml/h unit (Describes the intensity of the |
| | fog effect in percentage with respect to |
| | the maximum intensity described in the |
| | device capability. If the intensity is not |
| | specified, this command shall be |
| | interpreted as turning on at the maximum |
| | intensity). |

Next, the XML representation syntax of a color correction type may be represented as the following Table 59. Herein, Table 59 is a table representing the XML representation syntax of the color correction type.

```
TABLE 59
<!-- ################################################ -->
<!--  Definition of DCV Color Correction Type  -->
<!-- ################################################ -->
<complexType name=“ColorCorrectionType”>
    <complexContent>
        <extension base=“iidl:DeviceCommandBaseType”>
              <sequence minOccurs=“0” maxOccurs=“unbounded”>
                      <element  name=“SpatialLocator”
type=“mpeg7:RegionLocatorType”/>
              </sequence>
        </extension>
    </complexContent>
</complexType>
```

Further, the binary encoding representation scheme or the binary representation of the syntax represented in Table 59 may be represented as the following Table 60. Herein, Table 60 is a table representing the binary representation syntax.

TABLE 60

| | Number of | |
|---|---|---|
| ColorCorrectionType{ | bits | Mnemonic |
| intensityFlag | 1 | bslbf |
| DeviceCommandBase | | DeviceCommandBaseType |
| LoopSpatialLocator | | vluimsbf5 |
| for(k=0;k< | | |
| LoopSpatialLocator;k++){ | | |
| SpatialLocator[k] | | mpeg7:RegionLocatorType |
| } | | |
| if(intensityFlag) { | | |
| intensity | 7 | uimsbf |
| } | | |
| } | | |

In addition, the semantics of the color correction type are represented as the following Table 61. Herein, Table 61 is a table representing the descriptor components semantics of the color correction type.

TABLE 61

| Name | Description |
|---|---|
| ColorCorrectionType | Tool for commanding a display device to |
| | perform color correction. |
| intensityFlag | This field, which is only present in the |
| | binary representation, signals the |
| | presence of device command attribute. A |
| | value of “1” means the attribute shall be |
| | used and “0” means the attribute shall not |
| | be used. |
| DeviceCommandBase | Provides the topmost type of the base type |
| | hierarchy which each individual device |
| | command can inherit. |
| LoopSpatialLocator | This field, which is only present in the |
| | binary representation, specifies the |
| | number of SpatialLocator contained in the |
| | description |
| SpatialLocator | Describes the spatial localization of the |
| | still region using SpatialLocatorType |
| | (optional), which indicates the regions in |
| | a video segment where the color correction |
| | effect is applied. The SpatialLocatorType |
| | is defined in ISO/IEC 15938-5 |
| Intensity | Describes the command value of the light |
| | device with respect to the default unit if |
| | the unit is not defined. Otherwise, use |
| | the unit type defined in the sensor |
| | capability. |

Next, the XML representation syntax of an initial color correction parameter type may be represented as the following Table 62. Herein, Table 62 is a table representing the XML representation syntax of the initial color correction parameter type.

```
TABLE 62
<!--
############################################################
-->
<!--  Definition of SDCmd Initialize Color Correction Parameter
Type -->
<!--
############################################################
-->
<complexType name=“InitializeColorCorrectionParameterType”>
    <complexContent>
        <extension base=“iidl:DeviceCommandBaseType”>
            <sequence>
                <element  name=“ToneReproductionCurves”
type=“mpegvct:ToneReproductionCurvesType” minOccurs=“0”/>
                <element  name=“ConversionLUT”
type=“mpegvct:ConversionLUTType”/>
                <element  name=“ColorTemperature”
type=“mpegvct:IlluminantType” minOccurs=“0”/>
                <element  name=“InputDeviceColorGamut”
type=“mpegvct:InputDeviceColorGamutType” minOccurs=“0”/>
                <element  name=“IlluminanceOfSurround”
type=“mpeg7:unsigned12” minOccurs=“0”/>
            </sequence>
        </extension>
    </complexContent>
</complexType>
```

Further, the binary encoding representation scheme or the binary representation of the syntax represented in Table 62 may be represented as the following Table 63. Herein, Table 63 is a table representing the binary representation syntax.

TABLE 63

| | Number of bits | Mnemonic |
|---|---|---|
| InitializeColorCorrectinParameterType{ | | |
| ToneReproductionCurvesFlag | 1 | bslbf |
| ConversionLUTFlag | 1 | bslbf |
| ColorTemperatureFlag | 1 | bslbf |
| InputDeviceColorGamutFlag | 1 | bslbf |
| IlluminanceOfSurroundFlag | 1 | bslbf |
| DeviceCommandBase | | DeviceCommandBaseType |
| if(ToneReproductionCurvesFlag) | | |
| { | | |
| ToneReproductionCurves | | ToneReproductionCurvesType |
| } | | |
| if(ConversionLUTFlag) { | | |
| ConversionLUT | | ConversionLUTType |
| } | | |
| if(ColorTemperatureFlag) { | | |
| ColorTemperature | | IlluminantType |
| } | | |
| if(InputDeviceColorGamutFlag) | | |
| { | | |
| InputDeviceColorGamut | | InputDeviceColorGamutType |
| } | | |
| if(IlluminanceOfSurroundFlag) | | |
| { | | |
| IlluminanceOfSurround | 12 | uimsbf |
| } | | |
| } | | |
| ToneReproductionCurvesType { | | |
| NumOfRecords | 8 | uimsbf |
| for(i=0;i< | | |
| NumOfRecords;i++){ | | |
| DAC_Value | 8 | mpeg7:unsigned8 |
| RGB_Value | 32 * 3 | mpeg7:doubleVector |
| } | | |
| } | | |
| ConversionLUTType { | | |
| RGB2XYZ_LUT | 32 * 3 * 3 | mpeg7:DoubleMatrixType |
| RGBScalar_Max | 32 * 3 | mpeg7:doubleVector |
| Offset_Value | 32 * 3 | mpeg7:doubleVector |
| Gain_Offset_Gamma | 32 * 3 * 3 | mpeg7:DoubleMatrixType |
| InverseLUT | 32 * 3 * 3 | mpeg7:DoubleMatrixType |
| } | | |
| IlluminantType { | | |
| ElementType | 1 | bslbf |
| if(ElementType==00){ | | |
| XY_Value | 32 * 2 | dia:ChromaticityType |
| Y_Value | 7 | uimsbf |
| }else | | |
| if(ElementType==01){ | | |
| Correlated_CT | 8 | uimsbf |
| } | | |
| } | | |
| InputDeviceColorGamutType | | |
| { | | |
| typeLength | | vluimsbf5 |
| IDCG_Type | 8 * typeLength | bslbf |
| IDCG_Value | 32 * 3 * 2 | mpeg7:DoubleMatrixType |
| } | | |

In addition, the semantics of the initial color correction parameter type are represented as the following Table 64. Herein, Table 64 is a table representing the descriptor components semantics of the initial color correction parameter type.

TABLE 64

| Name | Description |
|---|---|
| InitializeColorCorrectinParameterType | Tool for describing an initialize color |
| | correction parameter command. |
| ToneReproductionCurvesFlag | This field, which is only present in the |
| | binary representation, signals the |
| | presence of device command attribute. A |
| | value of “1” means the attribute shall be |
| | used and “0” means the attribute shall not |
| | be used. |
| ConversionLUTFlag | This field, which is only present in the |
| | binary representation, signals the |
| | presence of device command attribute. A |
| | value of “1” means the attribute shall be |
| | used and “0” means the attribute shall not |
| | be used. |
| ColorTemperatureFlag | This field, which is only present in the |
| | binary representation, signals the |
| | presence of device command attribute. A |
| | value of “1” means the attribute shall be |
| | used and “0” means the attribute shall not |
| | be used. |
| InputDeviceColorGamutFlag | This field, which is only present in the |
| | binary representation, signals the |
| | presence of device command attribute. A |
| | value of “1” means the attribute shall be |
| | used and “0” means the attribute shall not |
| | be used. |
| IlluminanceOfSurroundFlag | This field, which is only present in the |
| | binary representation, signals the |
| | presence of device command attribute. A |
| | value of “1” means the attribute shall be |
| | used and “0” means the attribute shall not |
| | be used. |
| DeviceCommandBase | Provides the topmost type of the base type |
| | hierarchy which each individual device |
| | command can inherit. |
| ToneReproductionCurves | This curve shows the characteristics |
| | (e.g., gamma curves for R, G and B |
| | channels) of the input display device. |
| ConversionLUT | A look-up table (matrix) converting an |
| | image between an image color space (e.g. RGB) |
| | and a standard connection space (e.g. CIE XYZ). |
| ColorTemperature | An element describing a white point |
| | setting (e.g., D65, D93) of the input |
| | display device. |
| InputDeviceColorGamut | An element describing an input display |
| | device color gamut, which is represented |
| | by chromaticity values of R, G, and B |
| | channels at maximum DAC values. |
| IlluminanceOfSurround | An element describing an illuminance level |
| | of viewing environment. The illuminance is |
| | represented by lux. |

In the descriptor component semantics of the initial color correction parameter type represented in Table 64, semantics of the tone reproduction curves type are as represented in the following Table 65. Herein, Table 65 is a table representing semantics of the tone reproduction curves type.

TABLE 65

| Names | Description |
|---|---|
| NumOfRecords | This field, which is only present in the |
| | binary representation, specifies the number |
| | of record (DAC and RGB value) instances |
| | accommodated in the |
| | ToneReproductionCurves. |
| DAC_Value | An element describing discrete DAC values |
| | of input device. |
| RGB_Value | An element describing normalized gamma |
| | curve values with respect to DAC values. |
| | The order of describing the RGB_Value is |
| | Rn, Gn, Bn. |

In the descriptor component semantics of the initial color correction parameter type represented in Table 64, semantics of the conversion LUT type are as represented in the following Table 66. Herein, Table 66 is a table representing semantics of the conversion LUT type.

TABLE 66

| Names | Description |
|---|---|
| RGB2XYZ_LUT | This look-up table (matrix) converts an |
| | image from RGB to CIE XYZ. The size of |
| | $[ \begin{matrix}{R}_{x} & {G}_{x} & {B}_{x} \\ {R}_{y} & {G}_{y} & {B}_{y} \\ {R}_{z} & {G}_{z} & {B}_{z}\end{matrix} ] [ \begin{matrix}{R}_{x} & {G}_{x} & {B}_{x} \\ {R}_{y} & {G}_{y} & {B}_{y} \\ {R}_{z} & {G}_{z} & {B}_{z}\end{matrix} ] \text{?} . is 3 \times 3 such as \text{?}$ $\text{?} \text{indicates text missing or illegible when filed}$ |
| | The way of describing the values in the binary |
| | representation is in the order of [RₓRₓ , |
| | GₓGₓ, BₓBₓ; R_{y}R_{y}, G_{y}G_{y}, B_{y}B_{y}; R_{z}R_{z}, G_{z}G_{z}, |
| | B_{z}B_{z}]. |
| RGBScalar_Max | An element describing maximum RGB scalar |
| | values for GOG transformation. The order |
| | of describing the RGBScalar_Max is Rmax, |
| | Gmax, Bmax. |
| Offset_Value | An element describing offset values of |
| | input display device when the DAC is 0. |
| | The value is described in CIE XYZ form. |
| | The order of describing the Offset_Value |
| | is X, Y, Z. |
| Gain_Offset_Gamma | An element describing the gain, offset, |
| | gamma of RGB channels for GOG |
| | transformation. The size of the [symbol] |
| | $[ \begin{matrix}{Gain}_{r} & {Gain}_{g} & {Gain}_{b} \\ {Offset}_{r} & {Offset}_{g} & {Offset}_{b} \\ {Gamma}_{r} & {Gamma}_{g} & {Gamma}_{b}\end{matrix} ] [ \begin{matrix}{Gain}_{r} & {Gain}_{g} & {Gain}_{b} \\ {Offset}_{r} & {Offset}_{g} & {Offset}_{b} \\ {Gamma}_{r} & {Gamma}_{g} & {Gamma}_{b}\end{matrix} ] . \text{?}$ $\text{?} \text{indicates text missing or illegible when filed}$ |
| | The way of describing the values in the |
| | binary representation is in the order of |
| | [Gainr, Gaing, Gainb; Offsetr, Offsetg, |
| | Offsetb; Gammar, Gammag, Gammab]. |
| | InverseLUTThis look-up table (matrix) |
| | converts an image form CIE XYZ to RGB. |
| | The size [symbol] atrix is 3 × 3 |
| | $such as [ \begin{matrix}{R}_{x}^{′} & {G}_{x}^{′} & {B}_{x}^{′} \\ {R}_{y}^{′} & {G}_{y}^{′} & {B}_{y}^{′} \\ {R}_{z}^{′} & {G}_{z}^{′} & {B}_{z}^{′}\end{matrix} ] [ \begin{matrix}{R}_{x}^{′} & {G}_{x}^{′} & {B}_{x}^{′} \\ {R}_{y}^{′} & {G}_{y}^{′} & {B}_{y}^{′} \\ {R}_{z}^{′} & {G}_{z}^{′} & {B}_{z}^{′}\end{matrix} ] .$ |
| | The way of describing the values in the binary |
| | representation is in the order of [Rₓ′Rₓ′, |
| | Gₓ′Gₓ′, Bₓ′Bₓ′; R_{y}′R_{y}′, G_{y}′G_{y}′, B_{y}′B_{y}′; R_{z}′R_{z}′, G_{z}′G_{z}′, |
| | B_{z}′B_{z}′]. |

[symbol]

indicates data missing or illegible when filed

Further, in the descriptor component semantics of the initial color correction parameter type represented in Table 64, semantics of the illuminant type are as represented in the following Table 67. Herein, Table 67 is a table representing the semantics of the illuminant type.

TABLE 67

| Names | Description |
|---|---|
| ElementType | This field, which is only present in the |
| | binary representation, describes which |
| | Illuminant scheme shall be used. |
| XY_Value | An element describing the chromaticity of |
| | the light source. The ChromaticityType is |
| | specified in ISO/IEC 21000-7. |
| Y_Value | An element describing the luminance of the |
| | light source between 0 and 100. |
| Correlated_CT | Indicates the correlated color temperature |
| | of the overall illumination. The value |
| | expression is obtained through quantizing |
| | the range [1667, 25000] into 28 bins in a |
| | non-uniform way as specified in ISO/IEC |
| | 15938-5. |

In the semantics of the illuminant type represented in Table 67, an element type may be represented by the binary representation as represented in the Table 68. That is, in the semantics of the illuminant type represented in Table 67, the element type is encoded by the binary representation. Herein, Table 68 is a table representing the binary representation of the element type.

TABLE 68

| Illuminant | IlluminantType |
|---|---|
| 00 | xy and Y value |
| 01 | Correlated_CT |

Further, in the descriptor component semantics of the initial color correction parameter type represented in Table 64, semantics of the input device color gamut type are as represented in the following Table 69. Herein, Table 69 is a table representing the semantics of the input device color gamut type.

TABLE 69

| Names | Description |
|---|---|
| typeLength | This field, which is only present in the |
| | binary representation, specifies the length |
| | of each IDCG_Type instance in bytes. The |
| | value of this element is the size of the |
| | largest IDCG_Type instance, aligned to a |
| | byte boundary by bit stuffing using 0-7 ‘1’ |
| | bits. |
| IDCG_Type | An element describing the type of input |
| | device color gamut (e.g., NTSC, SMPTE). |
| IDCG_Value | An element describing the chromaticity |
| | values of RGB channels when the DAC values |
| | are maximum. The size [symbol] G_Value |
| | $matrix is 3 \times 2 such as [ \begin{matrix}{x}_{r} & {y}_{r} \\ {x}_{g} & {y}_{g} \\ {x}_{b} & {y}_{b}\end{matrix} ] [ \begin{matrix}{x}_{r} & {y}_{r} \\ {x}_{g} & {y}_{g} \\ {x}_{b} & {y}_{b}\end{matrix} ] .$ |
| | The way of describing the values in the binary |
| | representation is in the order of [xᵣxᵣ, yᵣyᵣ, |
| | x_{g}x_{g}, y_{g}y_{g}, x_{b}x_{b}, y_{b}y_{b}]. |

[symbol]

indicates data missing or illegible when filed

Next, the XML representation syntax of a rigid body motion type may be represented as the following Table 70. Herein, Table 70 is a table representing the XML representation syntax of the rigid body motion type.

```
TABLE 70
<!-- ################################################ -->
<!--  Definition of Rigid Body Motion Type  -->
<!-- ################################################ -->
<complexType name=“RigidBodyMotionType”>
    <complexContent>
        <extension base=“iidl:DeviceCommandBaseType”>
            <sequence>
                <element  name=“MoveToward”
type=“dcv:MoveTowardType” minOccurs=“0”/>
                    <element  name=“Incline”
type=“dcv:InclineType” minOccurs=“0”/>
            </sequence>
                <attribute name=“duration” type=“float”/>
        </extension>
    </complexContent>
</complexType>
<complexType name=“MoveTowardType”>
      <attribute name=“directionX” type=“float”/>
      <attribute name=“directionY” type=“float”/>
      <attribute name=“directionZ” type=“float”/>
      <attribute name=“speedX” type=“float”/>
      <attribute name=“speedY” type=“float”/>
      <attribute name=“speedZ” type=“float”/>
      <attribute name=“accelerationX” type=“float”/>
      <attribute name=“accelerationY” type=“float”/>
      <attribute name=“accelerationZ” type=“float”/>
</complexType>
<complexType name=“InclineType”>
      <attribute  name=“PitchAngle”
type=“mpegvct:InclineAngleType” use=“optional”/>
      <attribute name=“YawAngle” type=“mpegvct:InclineAngleType”
use=“optional”/>
      <attribute  name=“RollAngle”
type=“mpegvct:InclineAngleType” use=“optional”/>
      <attribute name=“PitchSpeed” type=“float” use=“optional”/>
      <attribute name=“YawSpeed” type=“float” use=“optional”/>
      <attribute name=“RollSpeed” type=“float” use=“optional”/>
      <attribute  name=“PitchAcceleration”  type=“float”
use=“optional”/>
      <attribute  name=“YawAcceleration”  type=“float”
use=“optional”/>
      <attribute  name=“RollAcceleration”  type=“float”
use=“optional”/>
</complexType>
```

Further, the binary encoding representation scheme or the binary representation of the syntax represented in Table 70 may be represented as the following Table 71. Herein, Table 71 is a table representing the binary representation syntax.

TABLE 71

| | Number | |
|---|---|---|
| RigidBodyMotionType{ | of bits | Mnemonic |
| MoveTowardFlag | 1 | bslbf |
| InclineFlag | 1 | bslbf |
| durationFlag | 1 | bslbf |
| DeviceCommandBase | | DeviceCommandBaseType |
| if( MoveTowardFlag ) { | | |
| MoveToward | | MoveTowardTypes |
| } | | |
| if( InclineFlag ) { | | |
| Incline | | InclineType |
| } | | |
| if(durationFlag) { | | |
| duration | 32 | fsbf |
| } | | |
| } | | |
| MoveTowardType{ | | |
| directionXFlag | 1 | bslbf |
| directionYFlag | 1 | bslbf |
| directionZFlag | 1 | bslbf |
| speedXFlag | 1 | bslbf |
| speedYFlag | 1 | bslbf |
| speedZFlag | 1 | bslbf |
| accelerationXFlag | 1 | bslbf |
| accelerationYFlag | 1 | bslbf |
| accelerationZFlag | 1 | bslbf |
| if( directionXFlag){ | | |
| directionX | 32 | fsbf |
| } | | |
| if( directionYFlag){ | | |
| directionY | 32 | fsbf |
| } | | |
| if( directionZFlag){ | | |
| directionZ | 32 | fsbf |
| } | | |
| if(speedXFlag){ | | |
| speedX | 32 | fsbf |
| } | | |
| if(speedYFlag){ | | |
| speedY | 32 | fsbf |
| } | | |
| if(speedZFlag){ | | |
| speedZ | 32 | fsbf |
| } | | |
| if(accelerationXFlag){ | | |
| accelerationX | 32 | fsbf |
| } | | |
| if(accelerationYFlag){ | | |
| accelerationY | 32 | fsbf |
| } | | |
| if(accelerationZFlag){ | | |
| accelerationZ | 32 | fsbf |
| } | | |
| } | | |
| InclineType{ | | |
| PitchAngleFlag | 1 | bslbf |
| YawAngleFlag | 1 | bslbf |
| RollAngleFlag | 1 | bslbf |
| PitchSpeedFlag | 1 | bslbf |
| YawSpeedFlag | 1 | bslbf |
| RollSpeedFlag | 1 | bslbf |
| PitchAccelerationFlag | 1 | bslbf |
| YawAccelerationFlag | 1 | bslbf |
| RollAccelerationFlag | 1 | bslbf |
| if(PitchAngleFlag){ | | |
| PitchAngle | 9 | simsbf |
| } | | |
| if(YawAngleFlag){ | | |
| YawAngle | | InclineAngleType |
| } | | |
| if(RollAngleFlag){ | | |
| RollAngle | | InclineAngleType |
| } | | |
| if(PitchSpeedFlag){ | | |
| PitchSpeed | 32 | fsbf |
| } | | |
| if(YawSpeedFlag){ | | |
| YawSpeed | 32 | fsbf |
| } | | |
| if(RollSpeedFlag){ | | |
| RollSpeed | 32 | fsbf |
| } | | |
| if(PitchAccelerationFlag) | | |
| { | | |
| PitchAcceleration | 32 | fsbf |
| } | | |
| if(YawAccelerationFlag){ | | |
| YawAcceleration | 32 | fsbf |
| } | | |
| if(RollAccelerationFlag){ | | |
| RollAcceleration | 32 | fsbf |
| } | | |
| } | | |
| FirstFlag | 1 | bslbf |
| MoveTowardFlag | 1 | bslbf |
| InclineFlag | 1 | bslbf |
| DeviceCommandBase | | DeviceCommandBaseType |
| if( FirstFlag ){ | 1 | bslbf |
| if( MoveTowardFlag ) | | |
| { | | |
| MoveToward | | MoveTowardType |
| } | | |
| if( InclineFlag ) { | | |
| Incline | | InclineType |
| } | | |
| } else { | | |
| if( MoveTowardFlag ) | | |
| { | | |
| MoveTowardMask | 9 | bslbf |
| NumOfModify | 3 | uimsbf |
| for( k=0;k<NumOfModify;k++ ) | | |
| { | | |
| MoveToward | | MoveTowardType |
| } | | |
| } | | |
| if( InclineFlag ) { | | |
| InclineMask | 9 | bslbf |
| NumOfModify | 3 | uimsbf |
| for( k=0;k<NumOfModify;k++ ) | | |
| { | | |
| Incline | | InclineType |
| } | | |
| } | | |
| } | | |
| } | | |

In addition, the semantics of the rigid body motion type are as represented in the following Table 72. Herein, Table 72 is a table representing the descriptor components semantics of the rigid body motion type.

TABLE 72

| Name | Description |
|---|---|
| RigidBodyMotionType | Type representing command information of |
| | rigid body motion (Tool for describing a |
| | rigid body motion device command). |
| MoveToward | Element representing motion for change of |
| | position (Describes the destination axis |
| | values of move toward effect. The type is |
| | defined by dcv:MoveTowardType). |
| MoveTowardFlag | This field, which is only present in the |
| | binary representation, signals the |
| | presence of device command attribute. A |
| | value of “1” means the attribute shall be |
| | used and “0” means the attribute shall not |
| | be used. |
| Incline | Element representing motion for change of |
| | agnle (Describes the rotation angle of |
| | incline effect. The type is defined by |
| | dcv:InclineType). |
| InclineFlag | This field, which is only present in the |
| | binary representation, signals the |
| | presence of device command attribute. A |
| | value of “1” means the attribute shall be |
| | used and “0” means the attribute shall not |
| | be used. |
| Duration | Attributes representing period up to end |
| | of motion (Describes time period during |
| | which the rigid body object should |
| | continuously move. The object which |
| | reaches the destination described by the |
| | description of RigidBodyMotionType should |
| | stay at the destination until it receives |
| | another command with activate = “false”). |
| durationFlag | This field, which is only present in the |
| | binary representation, signals the |
| | presence of device command attribute. A |
| | value of “1” means the attribute shall be |
| | used and “0” means the attribute shall not |
| | be used. |
| MoveTowardType | Type for MoveToward element (Tool for |
| | describing MoveToward commands for each |
| | axis) |
| DeviceCommandBase | Provides the topmost type of the base type |
| | hierarchy which each individual device |
| | command can inherit. |
| directionXFlag | This field, which is only present in the |
| | binary representation, signals the |
| | presence of device command attribute. A |
| | value of “1” means the attribute shall be |
| | used and “0” means the attribute shall not |
| | be used. |
| directionYFlag | This field, which is only present in the |
| | binary representation, signals the |
| | presence of device command attribute. A |
| | value of “1” means the attribute shall be |
| | used and “0” means the attribute shall not |
| | be used. |
| directionZFlag | This field, which is only present in the |
| | binary representation, signals the |
| | presence of device command attribute. A |
| | value of “1” means the attribute shall be |
| | used and “0” means the attribute shall not |
| | be used. |
| directionX | Represent degree of motion in x-axis |
| | direction (Describes the position command |
| | on x-axis in terms of centimeter with |
| | respect to the current position). |
| directionY | Represent degree of motion in y-axis |
| | direction (Describes the position command |
| | on y-axis in terms of centimeter with |
| | respect to the current position). |
| directionZ | Represent degree of motion in z-axis |
| | direction (Describes the position command |
| | on z-axis in terms of centimeter with |
| | respect to the current position). |
| Speed | This field, which is only present in the |
| XFlag | binary representation, signals the |
| | presence of device command attribute. A |
| | value of “1” means the attribute shall be |
| | used and “0” means the attribute shall not |
| | be used. |
| speedYFlag | This field, which is only present in the |
| | binary representation, signals the |
| | presence of device command attribute. A |
| | value of “1” means the attribute shall be |
| | used and “0” means the attribute shall not |
| | be used. |
| speedZFlag | This field, which is only present in the |
| | binary representation, signals the |
| | presence of device command attribute. A |
| | value of “1” means the attribute shall be |
| | used and “0” means the attribute shall not |
| | be used. |
| speedX | Represent speed in x-axis direction |
| | (Describes the desired speed of the rigid |
| | body object on the x-axis in terms of |
| | percentage with respect to the maximum |
| | speed of the specific device which also be |
| | described in the device capability as |
| | defined in Part 2 of ISO/IEC 23005). |
| SpeedY | Represent speed in y-axis direction |
| | (Describes the desired speed of the rigid |
| | body object on the y-axis in terms of |
| | percentage with respect to the maximum |
| | speed of the specific device which also be |
| | described in the device capability as |
| | defined in Part 2 of ISO/IEC 23005). |
| speedZ | Represent speed in z-axis direction |
| | (Describes the desired speed of the rigid |
| | body object on the z-axis in terms of |
| | percentage with respect to the maximum |
| | speed of the specific device which also be |
| | described in the device capability as |
| | defined in Part 2 of ISO/IEC 23005). |
| accelerationXFlag | This field, which is only present in the |
| | binary representation, signals the |
| | presence of device command attribute. A |
| | value of “1” means the attribute shall be |
| | used and “0” means the attribute shall not |
| | be used. |
| accelerationYFlag | This field, which is only present in the |
| | binary representation, signals the |
| | presence of device command attribute. A |
| | value of “1” means the attribute shall be |
| | used and “0” means the attribute shall not |
| | be used. |
| accelerationZFlag | This field, which is only present in the |
| | binary representation, signals the |
| | presence of device command attribute. A |
| | value of “1” means the attribute shall be |
| | used and “0” means the attribute shall not |
| | be used. |
| accelerationX | Represent acceleration in x-axis direction |
| | (Describes the desired acceleration of the |
| | rigid body object on the x-axis in terms |
| | of percentage with respect to the maximum |
| | acceleration of the specific device which |
| | may be described in the device capability |
| | as defined in Part 2 of ISO/IEC 23005). |
| accelerationY | Represent accleration in y-axis direction |
| | (Describes the desired acceleration of the |
| | rigid body object on the y-axis in terms |
| | of percentage with respect to the maximum |
| | acceleration of the specific device which |
| | may be described in the device capability |
| | as defined in Part 2 of ISO/IEC 23005). |
| accelerationZ | Represent accleration in z-axis direction |
| | (Describes the desired acceleration of the |
| | rigid body object on the z-axis in terms |
| | of percentage with respect to the maximum |
| | acceleration of the specific device which |
| | may be described in the device capability |
| | as defined in Part 2 of ISO/IEC 23005). |
| InclineType | Type commanding incline for each axis |
| | (Tool for describing Incline commands for |
| | each axis). |
| PitchAngleFlag | This field, which is only present in the |
| | binary representation, signals the |
| | presence of device command attribute. A |
| | value of “1” means the attribute shall be |
| | used and “0” means the attribute shall not |
| | be used. |
| YawAngleFlag | This field, which is only present in the |
| | binary representation, signals the |
| | presence of device command attribute. A |
| | value of “1” means the attribute shall be |
| | used and “0” means the attribute shall not |
| | be used. |
| RollAngleFlag | This field, which is only present in the |
| | binary representation, signals the |
| | presence of device command attribute. A |
| | value of “1” means the attribute shall be |
| | used and “0” means the attribute shall not |
| | be used. |
| PitchAngle | Represent incline from −180° to +180° |
| | based on y axis (Describes the angle to |
| | rotate in y-axis, θ(pitch) in degrees |
| | between −180 and 180). |
| YawAngle | Represent incline from −180° to +180° |
| | based on z axis(Describes the angle to |
| | rotate in z-axis, ψ(yaw) in degrees |
| | between −180 and 180.). |
| RollAngle | Represent incline from −180° to +180° |
| | based on X axis (Describes the angle to |
| | rotate in x-axis, φ(roll), in degrees |
| | between −180 and 180.). |
| PitchSpeedFlag | This field, which is only present in the |
| | binary representation, signals the |
| | presence of device command attribute. A |
| | value of “1” means the attribute shall be |
| | used and “0” means the attribute shall not |
| | be used. |
| YawSpeedFlag | This field, which is only present in the |
| | binary representation, signals the |
| | presence of device command attribute. A |
| | value of “1” means the attribute shall be |
| | used and “0” means the attribute shall not |
| | be used. |
| RollSpeedFlag | This field, which is only present in the |
| | binary representation, signals the |
| | presence of device command attribute. A |
| | value of “1” means the attribute shall be |
| | used and “0” means the attribute shall not |
| | be used. |
| PitchSpeed | Represent angular velocity for Pitch |
| | incline (Describes the desired speed |
| | (command) of rotation for pitch in terms |
| | of percentage with respect to the maximum |
| | angular speed of the specific device which |
| | may be described in the device capability |
| | as defined in Part 2 of ISO/IEC 23005). |
| YawSpeed | Represent angular velocity for Yaw incline |
| | (Describes the desired speed (command) of |
| | rotation for yaw in terms of percentage |
| | with respect to the maximum angular speed |
| | of the specific device which may be |
| | described in the device capability as |
| | defined in Part 2 of ISO/IEC 23005). |
| RollSpeed | Represent angular velocity for Roll |
| | incline (Describes the desired speed |
| | (command) of rotation for roll in terms of |
| | percentage with respect to the maximum |
| | angular speed of the specific device which |
| | may be described in the device capability |
| | as defined in Part 2 of ISO/IEC 23005). |
| PitchAccelerationFlag | This field, which is only present in the |
| | binary representation, signals the |
| | presence of device command attribute. A |
| | value of “1” means the attribute shall be |
| | used and “0” means the attribute shall not |
| | be used. |
| YawAccelerationFlag | This field, which is only present in the |
| | binary representation, signals the |
| | presence of device command attribute. A |
| | value of “1” means the attribute shall be |
| | used and “0” means the attribute shall not |
| | be used. |
| RollAccelerationFlag | This field, which is only present in the |
| | binary representation, signals the |
| | presence of device command attribute. A |
| | value of “1” means the attribute shall be |
| | used and “0” means the attribute shall not |
| | be used. |
| PitchAcceleration | Represent angularr acceleration for Pitch |
| | incline (Describes the desired |
| | acceleration (command) of rotation for |
| | pitch in terms of percentage with respect |
| | to the maximum angular acceleration of the |
| | specific device which may be described in |
| | the device capability as defined in Part 2 |
| | of ISO/IEC 23005). |
| YawAcceleration | Represent angularr acceleration for Yaw |
| | incline (Describes the desired |
| | acceleration (command) of rotation for yaw |
| | in terms of percentage with respect to the |
| | maximum angular acceleration of the |
| | specific device which may be described in |
| | the device capability as defined in Part 2 |
| | of ISO/IEC 23005). |
| RollAcceleration | Represent angularr acceleration for Roll |
| | incline (Describes the desired |
| | acceleration (command) of rotation for |
| | roll in terms of percentage with respect |
| | to the maximum angular acceleration of the |
| | specific device which may be described in |
| | the device capability as defined in Part 2 |
| | of ISO/IEC 23005). |
| FirstFlag | This field, which is only present in the |
| | binary representation, signals the |
| | presence of device command attribute. A |
| | value of “1” means the attribute shall be |
| | used and “0” means the attribute shall not |
| | be used. |
| MoveTowardMask | This field, which is only present in the |
| | binary syntax, specifies a bit-field that |
| | indicates whether a MoveToward is assigned |
| | to the corresponding partition. |
| NumOfModify | This field, which is only present in the |
| | binary representation, specifies the |
| | number of modified elements contained in |
| | the description. |
| InclineMask | This field, which is only present in the |
| | binary syntax, specifies a bit-field that |
| | indicates whether an Incline is assigned |
| | to the corresponding partition. |

Next, the XML representation syntax of a tactile type may be represented as the following Table 73. Herein, Table 73 is a table representing the XML representation syntax of the tactile type.

```
TABLE 73
<!-- ################################################ -->
<!--  Definition of DCV Tactile Type  -->
<!-- ################################################ -->
<complexType name=“TactileType”>
    <complexContent>
        <extension base=“iidl:DeviceCommandBaseType”>
            <sequence>
                <element  name=“array_intensity”
type=“mpeg7:FloatMatrixType”/>
            </sequence>
        </extension>
    </complexContent>
</complexType>
```

Further, the binary encoding representation scheme or the binary representation of the syntax represented in Table 73 may be represented as the following Table 74. Herein, Table 74 is a table representing the binary representation syntax.

TABLE 74

| | Number of | |
|---|---|---|
| TactileType{ | bits | Mnemonic |
| DeviceCommandBase | | DeviceCommandBaseType |
| dimX | 4 | uimsbf |
| dimY | 16 | uimsbf |
| For (k=0;k<dimX*dimY;k++) | | |
| { | | |
| array_intensity[k] | 32 | fsbf |
| } | | |
| } | | |

Further, the binary encoding representation scheme or the binary representation of the syntax represented in Table 73 may be represented as the following Table 75. Herein, Table 75 is a table representing the binary representation syntax.

TABLE 75

| | Number | |
|---|---|---|
| TactileType{ | of bits | Mnemonic |
| DeviceCommandBaseType | | DeviceCommandBaseType |
| SizeOfIntensityRow | 4 | uimsbf |
| SizeOfIntensityColumn | 16 | uimsbf |
| for(k=0;k<(SizeOfIntensityRow* | | |
| SizeOfIntensityColumn);k++) | | |
| { | | |
| ArrayInstensity[k] | 32 | fsfb |
| } | | |
| } | | |

In addition, the semantics of the tactile type are represented as the following Table 76. Herein, Table 76 is a table representing the descriptor components semantics of the tactile type.

TABLE 76

| Name | Description |
|---|---|
| TactileType | Type representing command information of |
| | tactile device (Tool for describing array- |
| | type tactile device command. A tactile |
| | device is composed of an array of |
| | actuators). |
| DeviceCommandBase | Provides the topmost type of the base type |
| | hierarchy which each individual device |
| | command can inherit. |
| dimX | This field, which is only present in the |
| | binary representation, specifies the x- |
| | direction size of ArrayIntensity. |
| dimY | This field, which is only present in the |
| | binary representation, specifies the y- |
| | direction size of ArrayIntensity. |
| array_intensity | Have output value of arrangement structure |
| | when considering tactile device (Describes |
| | the intensities of array actuators in |
| | percentage with respect to the maximum |
| | intensity described in the device |
| | capability. If the intensity is not |
| | specified, this command shall be |
| | interpreted as turning on at the maximum |
| | intensity). |

Next, the XML representation syntax of a kinesthetic type may be represented as the following Table 77. Herein, Table 77 is a table representing the XML representation syntax of the kinesthetic type.

TABLE 77

```
<!-- ################################################ -->
<!-- Definition of DCV Kinesthetic Type -->
<!-- ################################################ -->
<complexType name=“KinestheticType”>
  <complexContent>
    <extension base=“iidl:DeviceCommandBaseType”>
      <sequence>
        <element name=“Position”
type=“mpegvct:Float3DVectorType” minOccurs=“0”/>
        <element name=“Orientation”
type=“mpegvct:Float3DVectorType” minOccurs=“0”/>
        <element name=“Force”
type=“mpegvct:Float3DVectorType” minOccurs=“0”/>
        <element name=“Torque”
type=“mpegvct:Float3DVectorType” minOccurs=“0”/>
        </sequence>
      </extension>
  </complexContent>
</complexType>
```

Further, the binary encoding representation scheme or the binary representation of the syntax represented in Table 77 may be represented as the following Table 78. Herein, Table 78 is a table representing the binary representation syntax.

TABLE 78

| | (Number | |
|---|---|---|
| KinesthestheticType{ | of bits) | (Mnemonic) |
| PositionFlag | 1 | bslbf |
| OrientationFlag | 1 | bslbf |
| ForceFlag | 1 | bslbf |
| TorqueFlag | 1 | bslbf |
| DeviceCommandBase | | DeviceCommandBaseType |
| if(PositionFlag){ | | |
| Position | | Float3DVectorType |
| } | | |
| if(OrientationFlag){ | | |
| Orientation | | Float3DVectorType |
| } | | |
| if(ForceFlag){ | | |
| Force | | Float3DVectorType |
| } | | |
| if(TorqueFlag){ | | |
| Torque | | Float3DVectorType |
| } | | |
| } | | |
| Float3DVectorType { | | |
| X | 32 | fsbf |
| Y | 32 | fsbf |
| Z | 32 | fsbf |
| } | | |

Further, the binary encoding representation scheme or the binary representation of the syntax represented in Table 77 may be represented as the following Table 79. Herein, Table 79 is a table representing the binary representation syntax.

TABLE 79

| | Number | |
|---|---|---|
| KinestheticType{ | of bits | Mnemonic |
| DeviceCommandBaseType | | DeviceCommandBaseType |
| PositionFlag | 1 | bslbf |
| If(PositionFlag){ | | |
| PositionX | 32 | fsfb |
| PositionY | 32 | fsfb |
| PositionZ | 32 | fsfb |
| } | | |
| OrientationFlag | 1 | bslbf |
| If(OrientationFlag){ | | |
| OrientationX | 32 | fsfb |
| OrientationY | 32 | fsfb |
| OrientationZ | 32 | fsfb |
| } | | |
| ForceFlag | 1 | bslbf |
| If(ForceFlag){ | | |
| ForceX | 32 | fsfb |
| ForceY | 32 | fsfb |
| ForceZ | 32 | fsfb |
| } | | |
| TorqueFlag | 1 | bslbf |
| If(TorqueFlag){ | | |
| TorqueX | 32 | fsfb |
| TorqueY | 32 | fsfb |
| TorqueZ | 32 | fsfb |
| } | | |
| } | | |

In addition, the semantics of the kinesthetic type are represented as the following Table 80. Herein, Table 80 is a table representing the descriptor components semantics of the kinesthetic type.

TABLE 80

| Name | Description |
|---|---|
| KinestheticType | Type representing command information of |
| | kinesthetic device (Describes a command |
| | for a kinesthetic device). |
| PositionFlag | This field, which is only present in the |
| | binary representation, signals the |
| | presence of device command attribute. A |
| | value of “1” means the attribute shall be |
| | used and “0” means the attribute shall not |
| | be used. |
| Position | Element representing position based on X, |
| | Y, Z axis (Describes the position that a |
| | kinesthetic device shall take in |
| | millimeters along each axis of X, Y, and |
| | Z, with respect to the idle position of |
| | the device). |
| OrientationFlag | This field, which is only present in the |
| | binary representation, signals the |
| | presence of device command attribute. A |
| | value of “1” means the attribute shall be |
| | used and “0” means the attribute shall not |
| | be used. |
| Orientation | Element representing incline based on X, |
| | Y, Z axis (Describes the orientation that |
| | a kinesthetic device shall take in degrees |
| | along each axis of X, Y, and Z, with |
| | respect to the idle orientation of the |
| | device). |
| ForceFlag | This field, which is only present in the |
| | binary representation, signals the |
| | presence of device command attribute. A |
| | value of “1” means the attribute shall be |
| | used and “0” means the attribute shall not |
| | be used. |
| Force | Element representing size of force |
| | (Describes the force of kinesthetic effect |
| | in percentage with respect to the maximum |
| | force described in the device capability. |
| | If the Force is not specified, this |
| | command shall be interpreted as turning on |
| | at the maximum force. This element takes |
| | Float3DVectorType type defined in Part 6 |
| | of ISO/IEC 23005). |
| TorqueFlag | This field, which is only present in the |
| | binary representation, signals the |
| | presence of device command attribute. A |
| | value of “1” means the attribute shall be |
| | used and “0” means the attribute shall not |
| | be used. |
| Torque | Element representing rotation force. Apply |
| | Float3DVectorType of ISO/IEC 23005 Part 6 |
| | (Describes the torque of kinesthetic |
| | effect in percentage with respect to the |
| | maximum torque described in the device |
| | capability. If the Torque is not |
| | specified, this command shall be |
| | interpreted as turning on at the maximum |
| | torque. This element takes |
| | Float3DVectorType type defined in Part 6 |
| | of ISO/IEC 23005). |
| Float3DVectorType | Tool for describing a 3D vector |
| X | Describes the sensed value in x-axis. |
| Y | Describes the sensed value in y-axis. |
| Z | Describes the sensed value in z-axis. |

Next, the XML representation syntax of the sensed information base type in the Binary representation on Sensed Information may be represented as the following Table 81. Herein, Table 81 is a table representing the XML representation syntax of the sensed information base type.

```
TABLE 81
  <!-- ################################################ -->
<!-- Sensed information base type -->
<!-- ################################################ -->
<complexType name=“SensedInfoBaseType” abstract=“true”>
  <sequence>
      <element name=“TimeStamp” type=“mpegvct:TimeStampType”
use=“optional” />
  </sequence>
    <attributeGroup ref=“iidl:SensedInfoBaseAttributes”/>
</complexType>
```

Further, the binary encoding representation scheme or the binary representation of the syntax represented in Table 81 may be represented as the following Table 82. Herein, Table 82 is a table representing the binary representation syntax.

TABLE 82

| | Number | |
|---|---|---|
| SensedInfoBaseTypeType{ | of bits | Mnemonic |
| TimeStampFlag | 1 | bslbf |
| SensedInfoBaseAttributes | | SensedInfoBaseAttributesType |
| If(TimeStampFlag){ | | |
| TimeStamp | | TimeStampType |
| } | | |
| } | | |

In addition, the semantics of the sensed information base type are as represented in the following Table 83. Herein, Table 83 is a table representing the descriptor components semantics of the sensed information base type.

TABLE 83

| Name | Description |
|---|---|
| SensedInfoBaseTypeType | Tool for describing sensed information |
| | base type. |
| TimeStampFlag | This field, which is only present in the |
| | binary representation, signals the |
| | presence of the timestamp element. A value |
| | of “1” means the timestamp shall be used |
| | and “0” means the timestamp shall not be |
| | used. |
| SensedInfoBaseAttributes | Provides the topmost type of the base type |
| | hierarchy which each individual sensed |
| | information can inherit. |
| TimeStamp | Provides the timing information for the |
| | sensed information to be executed. As |
| | defined in Part 6 of ISO/IEC 23005, there |
| | is a choice of selection among three |
| | timing schemes, which are absolute time, |
| | clock tick time, and delta of clock tick |
| | time |

Next, the XML representation syntax of the sensed information base type may be represented as the following Table 84. Herein, Table 84 is a table representing the XML representation syntax of the sensed information base type.

```
TABLE 84
<!-- ################################################ -->
  <!-- Definition of Sensed information Base Attributes -->
  <!-- ################################################ -->
  <attributeGroup name=“SensedInfoBaseAttributes”>
  <attribute name=“id” type=“ID” use=“optional”/>
  <attribute name=“sensorIdRef” type=“anyURI”
use=“optional”/>
  <attribute name=“linkedlist” type=“anyURI”
use=“optional”/>
  <attribute name=“groupID” type=“anyURI” use=“optional”/>
  <attribute name=“priority” type=“positiveInteger”
use=“optional”/>
  <attribute name=“activate” type=“boolean” use=“optional”/>
</attributeGroup>
```

Further, the binary encoding representation scheme or the binary representation of the syntax represented in Table 84 may be represented as the following Table 85. Herein, Table 85 is a table representing the binary representation syntax.

TABLE 85

| SensedInfoBaseAttributesType { | Number of bits | Mnemonic |
|---|---|---|
| IDFlag | 1 | bslbf |
| sensorIdRefFlag | 1 | bslbf |
| linkedlistFlag | 1 | bslbf |
| groupIDFlag | 1 | bslbf |
| priorityFlag | 1 | bslbf |
| activateFlag | 1 | bslbf |
| If(IDFlag) { | | |
| ID | See ISO 10646 | UTF-8 |
| } | | |
| if(sensorIdRefFlag) { | | |
| sensorIdRef | | UTF-8 |
| } | | |
| if(linkedlistFlag) { | | |
| linkedlist | | UTF-8 |
| } | | |
| if(groupIDFlag) { | | |
| groupID | | UTF-8 |
| } | | |
| If(priorityFlag) { | | |
| priority | 8 | uimsbf |
| } | | |
| if(activateFlag) { | | |
| activate | 1 | bslbf |
| } | | |
| } | | |

In addition, the semantics oz the sensed information base type are as represented in the following Table 86. Herein, Table 86 is a table representing the descriptor components semantics of the sensed information base type.

TABLE 86

| Name | Description |
|---|---|
| SensedInfoBaseAttributesType | Tool for describing sensed information |
| | base attributes. |
| IDFlag | This field, which is only present in the |
| | binary representation, signals the |
| | presence of the ID attribute. A value of |
| | “1” means the attribute shall be used |
| | and “0” means the attribute shall not |
| | be used. |
| sensorIdRefFlag | This field, which is only present in the |
| | binary representation, signals the |
| | presence of the sensor ID reference |
| | attribute. A value of “1” means the |
| | attribute shall be used and “0” means |
| | the attribute shall not be used. |
| linkedlistFlag | This field, which is only present in the |
| | binary representation, signals the |
| | presence of the linked list attribute. A |
| | value of “1” means the attribute shall be |
| | used and “0” means the attribute shall |
| | not be used. |
| groupIDFlag | This field, which is only present in the |
| | binary representation, signals the |
| | presence of the group ID attribute. A |
| | value of “1” means the attribute shall be |
| | used and “0” means the attribute shall |
| | not be used. |
| priorityFlag | This field, which is only present in the |
| | binary representation, signals the |
| | presence of the priority attribute. A |
| | value of “1” means the attribute shall be |
| | used and “0” means the attribute shall |
| | not be used. |
| activateFlag | This field, which is only present in the |
| | binary representation, signals the |
| | presence of the activation attribute. A |
| | value of “1” means the attribute shall be |
| | used and “0” means the attribute shall |
| | not be used. |
| ID | ID to identify the sensed information |
| | with respect to a light sensor. |
| sensorIdRef | References a sensor that has generated |
| | the information included in this |
| | specific sensed information. |
| linkedlist | Identifier for the next sensor of the |
| | multi-sensor structure that consists of a |
| | group of sensors in a way that each |
| | record contains a reference to the ID |
| | of the next sensor. |
| groupID | Identifier for a group multi-sensor |
| | structure to which this light sensor |
| | belongs. |
| priority | Describes a priority for sensed |
| | information with respect to other sensed |
| | information sharing the same point in |
| | time when the sensed information |
| | becomes adapted. A value of zero |
| | indicates the highest priority and |
| | larger values indicate lower priorities. |
| | The default value of the priority is |
| | zero. If there is more than one sensed |
| | information with the same priority, |
| | the order of process can be |
| | determined by the adaptation engine |
| | itself. |
| Activate | Describes whether the sensor is |
| | activated. A value of “1” means |
| | the sensor is activated and “0” |
| | means the sensor is deactivated. |

Next, the XML representation syntax of the time stamp type may be represented as the following Table 87. Herein, Table 87 is a table representing the XML representation syntax of the time stamp type.

TABLE 87

```
<complexType name=“TimeStampType” abstract=“true”/>
<complexType name=“AbsoluteTimeType”>
  <complexContent>
    <extension base=“ct:TimeStampType”>
      <attribute name=“absTimeScheme” type=“string”
use=“optional”/>
      <attribute name=“absTime” type=“string”/>
    </extension>
  </complexContent>
</complexType>
<complexType name=“ClockTickTimeType”>
  <complexContent>
    <extension base=“ct:TimeStampType”>
      <attribute name=“timeScale” type=“unsignedInt”
use=“optional”/>
      <attribute name=“pts” type=“nonNegativeInteger”/>
    </extension>
  </complexContent>
</complexType>
<complexType name=“ClockTickTimeDeltaType”>
  <complexContent>
    <extension base=“ct:TimeStampType”>
      <attribute name=“timeScale” type=“unsignedInt”
use=“optional”/>
      <attribute name=“ptsDelta” type=“unsignedInt”/>
    </extension>
  </complexContent>
</complexType>
```

Further, the binary encoding representation scheme or the binary representation of the syntax represented in Table 87 may be represented as the following Table 88. Herein, Table 88 is a table representing the binary representation syntax.

TABLE 88

| TimeStampType { | | |
|---|---|---|
| TimeStampSelect | 2 | bslbf |
| If(TimeStampSelect==1 | | |
| ){ | | |
| AbsoluteTimeStamp | | AbsoluteTimeStampType |
| } else if | | |
| (TimeStampSelect==2){ | | |
| ClockTickTimeStamp | | ClockTickTimeStampType |
| } else if | | |
| (TimeStampSelect==3){ | | |
| ClockTickTimeDeltaStamp | | ClockTickTimeDeltaStampType |
| } | | |
| } | | |
| | Number | |
| AbsoluteTimeStampType{ | of bits | Mnemonic |
| absTimeSchemeFlag | 1 | bslbf |
| if(absTimeSchemeFlag) | | |
| { | | |
| absTimeScheme | | UTF-8 |
| } | | |
| absTime | | UTF-8 |
| } | | |
| | Number | |
| ClockTickTimeType { | of bits | Mnemonic |
| timeScaleFlag | 1 | bslbf |
| if(timeScaleFlag){ | | |
| timeScale | 32 | uimsbf |
| } | | |
| pts | | vluimsbf5 |
| } | | |
| | Number | |
| ClockTickTimeDeltaType{ | of bits | Mnemonic |
| timeScaleFlag | 1 | bslbf |
| if(timeScaleFlag){ | | |
| timeScale | 32 | uimsbf |
| } | | |
| ptsDelta | 32 | uimsbf |
| } | | |

In addition, the semantics of the time stamp type are represented as the following Table 89. Herein, Table 89 is a table representing the descriptor components semantics of the time stamp type.

TABLE 89

| Name | Description |
|---|---|
| TimeStampType | Tools for Providing the timing information |
| | for the device command to be executed. As |
| | defined in Part 6 of ISO/IEC 23005, there |
| | is a choice of selection among three |
| | timing schemes, which are absolute time, |
| | clock tick time, and delta of clock tick |
| | time |
| TimeStampSelect | This field, which is only present in the |
| | binary representation, describes which |
| | time stamp scheme shall be used. “00” |
| | means that the absolute time stamp type |
| | shall be used, “01” means that the clock |
| | tick time stamp type shall be used, and |
| | “10” means that the clock tick time delta |
| | stamp type shall be used. |
| AbsoluteTimeStamp | The absolute time stamp is defined in |
| | A.2.3 of ISO/IEC 23005-6. |
| ClockTickTimeStamp | The clock tick time stamp is defined in |
| | A.2.3 of ISO/IEC 23005-6. |
| ClockTickTimeDeltaStamp | The clock tick time delta stamp, which |
| | value is the time delta between the |
| | present and the past time, is defined in |
| | A.2.3 of ISO/IEC 23005-6. |
| AbsoluteTimeStampType | Tools for Providing the absolute timing |
| | information for the sensed information. |
| ClockTickTimeType | Tools for Providing the clock tick timing |
| | information for the sensed information. |
| ClockTickTimeDeltaType | Tools for Providing the delta of clock |
| | tick timing information for the sensed |
| | information. |
| absTimeSchemeFlag | This field, which is only present in the |
| | binary representation, describes whether |
| | an optional absolute time stamp scheme |
| | shall be selected or not. |
| absTimeScheme | Specifies the absolute time scheme used in |
| | the format of string. See the annex C of |
| | ISO/IEC 21000-17:2006 for examples of |
| | time schemes syntax. If mpeg-7 time |
| | scheme is used, the value for this field |
| | shall be “mp7t” |
| absTime | Provides value of time information in the |
| | format defined in the absolute time scheme |
| | specified in absTimeScheme attribute. |
| timeScaleFlag | This field, which is only present in the |
| | binary representation, describes whether a |
| | time scale element shall be used or not. |
| timeScale | An optional attribute to provide the time |
| | scale for the clock tick, i.e. the number |
| | of clock ticks per second. |
| pts | Specifies the number of clock ticks from |
| | the origin of the target device. |
| timeScaleFlag | This field, which is only present in the |
| | binary representation, describes whether a |
| | time scale element shall be used or not. |
| timeScale | An optional attribute to provide the time |
| | scale for the clock tick, i.e. the number |
| | of clock ticks per second. |
| ptsDelta | Specifies the number of clock ticks from |
| | the time point specified by the last |
| | timing information provided. |

Herein, the binary representation of CS unit may be represented as the following table 89 and Table 89 is a table representing the binary representation of unit CS of CS unit.

TABLE 90

| unitType (8 bits) | Term ID of unit |
|---|---|
| 00000000 | micrometer |
| 00000001 | mm |
| 00000010 | cm |
| 00000011 | meter |
| 00000100 | km |
| 00000101 | inch |
| 00000110 | yard |
| 00000111 | mile |
| 00001000 | mg |
| 00001001 | gram |
| 00001010 | kg |
| 00001011 | ton |
| 00001100 | micrometerpersec |
| 00001101 | mmpersec |
| 00001110 | cmpersec |
| 00001111 | meterpersec |
| 00010000 | Kmpersec |
| 00010001 | inchpersec |
| 00010010 | yardpersec |
| 00010011 | milepersec |
| 00010100 | micrometerpermin |
| 00010101 | mmpermin |
| 00010110 | cmpermin |
| 00010111 | meterpermin |
| 00011000 | kmpermin |
| 00011001 | inchpermin |
| 00011010 | yardpermin |
| 00011011 | milepermin |
| 00011100 | micrometerperhour |
| 00011101 | mmperhour |
| 00011110 | cmperhour |
| 00011111 | meterperhour |
| 00100000 | kmperhour |
| 00100001 | inchperhour |
| 00100010 | yardperhour |
| 00100011 | mileperhour |
| 00100100 | micrometerpersecsquare |
| 00100101 | mmpersecsquare |
| 00100110 | cmpersecsquare |
| 00100111 | meterpersecsquare |
| 00101000 | kmpersecsquare |
| 00101001 | inchpersecsquare |
| 00101010 | yardpersecsquare |
| 00101011 | milepersecsquare |
| 00101100 | micormeterperminsquare |
| 00101101 | mmperminsquare |
| 00101110 | cmperminsquare |
| 00101111 | meterperminsquare |
| 00110000 | kmpersminsquare |
| 00110001 | inchperminsquare |
| 00110010 | yardperminsquare |
| 00110011 | mileperminsquare |
| 00110100 | micormeterperhoursquare |
| 00110101 | mmperhoursquare |
| 00110110 | cmperhoursquare |
| 00110111 | meterperhoursquare |
| 00111000 | kmperhoursquare |
| 00111001 | inchperhoursquare |
| 00111010 | yardperhoursquare |
| 00111011 | mileperhoursquare |
| 00111100 | Newton |
| 00111101 | Nmm |
| 00111110 | Npmm |
| 00111111 | Hz |
| 01000000 | KHz |
| 01000001 | MHz |
| 01000010 | GHz |
| 01000011 | volt |
| 01000100 | millivolt |
| 01000101 | ampere |
| 01000110 | milliampere |
| 01000111 | milliwatt |
| 01001000 | watt |
| 01001001 | kilowatt |
| 01001010 | lux |
| 01001011 | celsius |
| 01001100 | fahrenheit |
| 01001101 | radian |
| 01001110 | degree |
| 01001111 | radpersec |
| 01010000 | degpersec |
| 01010001 | radpersecsquare |
| 01010010 | degpersecsquare |
| 01010011 | Npermmsquare |
| 01011100-11111111 | Reserved |

In addition, the binary representation of float 3D vector type may be represented as the following Table 91 and Table 91 is a table representing the binary representation of float 3D vector type.

TABLE 91

| Names | Description |
|---|---|
| Float3DVectorType | Tool for describing a 3D position vector |
| X | Describes the sensed position in x-axis in |
| | the unit of meter. |
| Y | Describes the sensed position in y-axis in |
| | the unit of meter. |
| Z | Describes the sensed position in z-axis in |
| | the unit of meter. |

Herein, the binary representation of the command information for each sensor type will be described. First, the XML representation syntax of the light sensor type may be represented as the following Table 92. Herein, Table 92 is a table representing the XML representation syntax of the light sensor type.

TABLE 92

```
<!--#################################### -->
  <!--Definition of Light Sensor type  -->
  <!--#################################### -->
  <complexType name=“LightSensorType”>
    <complexContent>
      <extension base=“iidl:SensedInfoBaseType”>
        <attribute name=“value” type=“float” use=“optional”/>
        <attribute name=“unit” type=“iidl:unitType”
use=“optional”/>
        <attribute name=“color” type=“iidl:colorType”
use=“optional”/>
      </extension>
    </complexContent>
  </complexType>
```

Further, the binary encoding representation scheme or the binary representation of the syntax represented in Table 92 may be represented as in the following Table 93. Herein, Table 93 is a table representing the binary representation syntax.

TABLE 93

| | Number of | |
|---|---|---|
| LightSensorType{ | bits | Mnemonic |
| valueFlag | 1 | bslbf |
| unitFlag | 1 | bslbf |
| colorFlag | 1 | bslbf |
| SensedInfoBaseType | | SensedInfoBaseTypeType |
| if(valueFlag) { | | |
| value | 32 | fsbf |
| } | | |
| if(unitFlag) { | | |
| unit | | unitType |
| } | | |
| if(colorFlag) { | | |
| color | | colorType |
| } | | |
| } | | |

In addition, the semantics of the light sensor type are represented as the following Table 94. Herein, Table 94 is a table representing the descriptor components semantics of the light sensor type.

TABLE 94

| Names | Description |
|---|---|
| LightSensorType | Tool for describing sensed information with |
| | respect to a light sensor. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1”means the |
| | user-definedshall be used and “0” means the |
| | user-definedshall not be used. |
| colorFlag | This field, which is only present in the |
| | binary representation, signals the presence |
| | of color attribute. A value of “1” means |
| | the attribute shall be used and “0”means |
| | the attribute shall not be used. |
| | SensedInfoBaseTypeProvides the topmost type |
| | of the base type hierarchy |
| | which each individual sensed information |
| | can inherit. |
| value | Describes the sensed value of the |
| | lightsensor with respect to the default |
| | unit if the unit is not defined. use the |
| | unit type defined in the sensor capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |
| color | Describes the list of colors which the |
| | lighting device can sense as a reference to |
| | a classification scheme term or as RGB |
| | value. A CS that may be used for this |
| | purpose is the ColorCSdefined in A.2.3 of |
| | ISO/IEC 23005-6 and use the binary |
| | representation defined above. |

Next, the XML representation syntax of the ambient noise sensor type may be represented as in the following Table 95. Herein, Table 95 is a table representing the XML representation syntax of the ambient nose sensor type.

TABLE 95

```
<!--################################ -->
  <!--Definition of Ambient Noise Sensor type -->
  <!--################################ -->
  <complexType name=“AmbientNoiseSensorType”>
    <complexContent>
      <extension base=“iidl:SensedInfoBaseType”>
        <attribute name=“lifespan” type=“float”
use=“optional”/>
        <attribute name=“value” type=“float” use=“optional”/>
        <attribute name=“unit” type=“iidl:unitType”
use=“optional”/>
      </extension>
    </complexContent>
  </complexType>
```

Further, the binary encoding representation scheme or the binary representation of the syntax represented in Table 95 may be represented as in the following Table 96. Herein, Table 96 is a table representing the binary representation syntax.

TABLE 96

| | Number of | |
|---|---|---|
| AmbientNoiseSensorType{ | bits | Mnemonic |
| lifespanFlag | 1 | bslbf |
| valueFlag | 1 | bslbf |
| unitFlag | 1 | bslbf |
| SensedInfoBaseType | | SensedInfoBaseTypeType |
| if(lifespanFlag) { | | |
| lifespan | 32 | fsbf |
| } | | |
| if(valueFlag) { | | |
| value | 32 | fsbf |
| } | | |
| if(unitFlag) { | | |
| unit | | unitType |
| } | | |
| } | | |

In addition, the semantics of the ambient noise sensor type are represented as the following Table 97. Herein, Table 97 is a table representing the descriptor components semantics of the ambient noise sensor type.

TABLE 97

| Names | Description |
|---|---|
| AmbientNoiseSensorType | Tool for describing sensed information with |
| | respect to an ambient noise sensor. |
| lifespanFlag | This field, which is only present in the |
| | binary representation, signals the presence |
| | of the life span attribute. A value of “1” |
| | means the lifespan shall be used and “0” |
| | means the lifespan shall not be used. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| | SensedInfoBaseTypeProvides the topmost |
| | type of the base type hierarchy |
| | which each individual sensed information |
| | can inherit. |
| lifespan | Describes the duration taken to measure the |
| | information based on the timestamp. |
| lifespan | Describes the sensed value of the ambient |
| | noise sensor with respect to the default |
| | unit if the unit is not defined. |
| | Otherwise, use the unit type defined in the |
| | sensor capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a temperature sensor type may be represented as in the following Table 98. Herein, Table 98 is a table representing the XML representation syntax of the temperature sensor type.

TABLE 98
<!--#################################### -->
<!--Definition of Temperature Sensor type -->
<!--#################################### -->
<complexType name=“TemperatureSensorType”>

<complexContent>

<extension base=“iidl:SensedInfoBaseType”>

<attribute name=“value” type=“float” use=“optional”/>
<attribute name=“unit” type=“iidl:unitType”

use=“optional”/>

</extension>

</complexContent>

</complexType>

Further, the binary encoding representation scheme or the binary representation of the syntax represented in Table 98 may be represented as the following Table 99. Herein, Table 99 is a table representing the binary representation syntax.

TABLE 99

| | | |
|---|---|---|
| | Number of | |
| TemperatureSensorType{ | bits | Mnemonic |

| | | |
|---|---|---|
| valueFlag | 1 | bslbf |
| unitFlag | 1 | bslbf |
| if(valueFlag) { | | |

| | | |
|---|---|---|
| value | 32 | fsbf |

}
if(unitFlag) {

| | |
|---|---|
| unit | unitType |

}

}

In addition, the semantics of the temperature sensor type are represented as the following Table 100. Herein, Table 100 is a table representing the descriptor components semantics of the temperature sensor type.

TABLE 100

| Names | Description |
|---|---|
| TemperatureSensorType | Tool for describing sensed information |
| | with respect to a temperature sensor. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseTypeProvides | |
| the topmost type of | |
| the base type | |
| hierarchy | |
| which each | |
| individual | |
| sensed | |
| information can | |
| inherit. | |
| value | Describes the sensed value of the |
| | temperature sensor with respect to the |
| | default unit if the unit is not defined. |
| | Otherwise, use the unit type defined in the |
| | sensor capability. |
| unit | Specifies the unit of the sensed value, if |
| | a unit other than the default unit is used, |
| | as a reference to a classification scheme |
| | term provided by UnitCS defined in xxx |
| | of ISO/IEC 23005-6 and use the binary |
| | representation defined above. |

Next, the XML representation syntax of a humidity sensor type may be represented as in the following Table 101. Herein, Table 101 is a table representing the XML representation syntax of the humidity sensor type.

TABLE 101

<!--#################################### -->

<!--Definition of Humidity Sensor type -->
<!--#################################### -->
<complexType name=“HumiditySensorType”>

<complexContent>

<extension base=“iidl:SensedInfoBaseType”>

<attribute name=“value” type=“float”

use=“optional”/>

<attribute name=“unit” type=“iidl:unitType”

use=“optional”/>

</extension>

</complexContent>

</complexType>

Further, the binary encoding representation scheme or the binary representation of the syntax represented in Table 101 may be represented as in the following Table 102. Herein, Table 102 is a table representing the binary representation syntax.

TABLE 102

| | | Number of | |
|---|---|---|---|
| HumiditySensorType{ | | bits | Mnemonic |
| | valueFlag | 1 | bslbf |
| | unitFlag | 1 | bslbf |
| | SensedInfoBaseType | | SensedInfoBaseTypeType |
| | if(valueFlag) { | | |

| | | |
|---|---|---|
| value | 32 | fsbf |

}
if(unitFlag) {

| | |
|---|---|
| Unit | unitType |

}

}

In addition, the semantics of the humidity sensor type are represented as the following Table 103. Herein, Table 103 is a table representing the descriptor components semantics of the humidity sensor type.

TABLE 103

| Names | Description |
|---|---|
| HumiditySensorType | Tool for describing sensed information with |
| | respect to a humidity sensor. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| | SensedInfoBaseTypeProvides the topmost type |
| | of the base type hierarchy |
| | which each individual sensed information |
| | can inherit. |
| value | Describes the sensed value of the humidity |
| | sensor with respect to the default unit if |
| | the unit is not defined. Otherwise, use |
| | the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a distance sensor type may be represented as in the following Table 104. Herein, Table 104 is a table representing the XML representation syntax of the distance sensor type.

TABLE 104

<!--#################################### -->

<!--Definition of Distance Sensor type -->
<!--#################################### -->

<complexType name=“DistanceSensorType”>

<complexContent>

<extension base=“iidl:SensedInfoBaseType”>

<attribute name=“value” type=“float”
use=“optional”/>
<attribute name=“unit” type=“iidl:unitType”

use=“optional”/>

</extension>

</complexContent>

</complexType>

Further, the binary encoding representation scheme or the binary representation of the syntax represented in Table 104 may be represented as the following Table 105. Herein, Table 105 is a table representing the binary representation syntax.

TABLE 105

| | | Number of | |
|---|---|---|---|
| DistanceSensorType{ | | bits | Mnemonic |
| | valueFlag | 1 | bslbf |
| | unitFlag | 1 | bslbf |
| | SensedInfoBaseType | | SensedInfoBaseTypeType |
| | if(valueFlag) { | | |

| | | |
|---|---|---|
| value | 32 | fsbf |

}
if(unitFlag) {

| | |
|---|---|
| unit | unitType |

}

}

In addition, the semantics of the distance sensor type are represented as the following Table 106. Herein, Table 106 is a table representing the descriptor components semantics of the distance sensor type.

TABLE 106

| Names | Description |
|---|---|
| DistanceSensorType | Tool for describing sensed information with |
| | respect to a distance sensor. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| | SensedInfoBaseTypeProvides the topmost type |
| | of the base type hierarchy |
| | which each individual sensed information |
| | can inherit. |
| value | Describes the sensed value of the distance |
| | sensor with respect to the default unit if |
| | the unit is not defined. Otherwise, use |
| | the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of an atmospheric pressure sensor type may be represented as in the following Table 107. Herein, Table 107 is a table representing the XML representation syntax of the atmospheric pressure sensor type.

TABLE 107

<!--#################################### -->
<!--Definition of Atmospheric pressure Sensor type -->
<!--#################################### -->
<complexType name=“AtmosphericPressureSensorType”>

<complexContent>

<extension base=“iidl:SensedInfoBaseType”>

<attribute name=“value” type=“float”

use=“optional”/>

<attribute name=“unit” type=“iidl:unitType”

use=“optional”/>

</extension>

</complexContent>

</complexType>

Further, the binary encoding representation scheme or the binary representation of the syntax represented in Table 107 may be represented as in the following Table 108. Herein, Table 108 is a table representing the binary representation syntax.

TABLE 108

| | | Number of | |
|---|---|---|---|
| AtmosphericPressureSensorType{ | | bits | Mnemonic |
| | valueFlag | 1 | bslbf |
| | unitFlag | 1 | bslbf |
| | SensedInfoBaseType | | SensedInfoBaseTypeType |
| | if(valueFlag) { | | |

| | | |
|---|---|---|
| value | 32 | fsbf |

}
if(unitFlag) {

| | |
|---|---|
| unit | unitType |

}

}

In addition, the semantics of the atmospheric pressure sensor type are represented as the following Table 109. Herein, Table 109 is a table representing the descriptor components semantics of the atmospheric pressure sensor type.

TABLE 109

| Names | Description |
|---|---|
| AtmosphericPressureSensorType | Tool for describing sensed information |
| | with respect to an atmospheric pressure |
| | sensor. |
| valueFlag | This field, which is only present in the |
| | binary representation, signals the |
| | presence of sensor value attribute. A |
| | value of “1” means the attribute shall |
| | be used and “0” means the attribute |
| | shall not be used. |
| unitFlag | This field, which is only present in the |
| | binary representation, signals the |
| | presence of unit attribute. A value of |
| | “1” means the user-defined unit shall |
| | be used and “0” means the user-defined |
| | unit shall not be used. |
| SensedInfoBaseType | Provides the topmost type of the base |
| | type hierarchy which each individual |
| | sensed information can inherit. |
| value | Describes the sensed value of the |
| | atmospheric pressure sensor with |
| | respect to the default unit if the unit is |
| | not defined. Otherwise, use the unit |
| | type defined in the sensor capability. |
| unit | Specifies the unit of the sensed value, if |
| | a unit other than the default unit is used, |
| | as a reference to a classification scheme |
| | term provided by UnitCS defined in xxx |
| | of ISO/IEC 23005-6 and use the |
| | binary representation defined above. |

Next, the XML representation syntax of a position sensor type may be represented as in the following Table 110. Herein, Table 110 is a table representing the XML representation syntax of the position sensor type.

TABLE 110

<!--#################################### -->

<!--Definition of Position Sensor type -->
<!--#################################### -->
<complexType name=“PositionSensorType”>
<complexContent>

<extension base=“iidl:SensedInfoBaseType”>

<sequence>

<element name=“position”

type=“mpegvct:Float3DVectorType” minOccurs=“0”/>

</sequence>
<attribute name=“unit” type=“mpegvct:unitType”

use=“optional”/>

</extension>

</complexContent>
</complexType>

Further, the binary encoding representation scheme or the binary representation of the syntax represented in Table 110 may be represented as in the following Table 111. Herein, Table 111 is a table representing the binary representation syntax.

TABLE 111

| | | Number of | |
|---|---|---|---|
| PositionSensorNormalType{ | | bits | Mnemonic |
| | positionFlag | 1 | bslbf |
| | unitFlag | 1 | bslbf |
| | SensedInfoBaseType | | SensedInfoBaseTypeType |
| | if(positionFlag) { | | |

| | |
|---|---|
| position | Float3DVectorType |

}
if(unitFlag) {

| | |
|---|---|
| unit | unitType |

}

}

In addition, the semantics of the position sensor type are represented as the following Table 112. Herein, Table 112 is a table representing the descriptor components semantics of the position sensor type.

TABLE 112

| Names | Description |
|---|---|
| PositionSensorType | Tool for describing sensed information with |
| | respect to a position sensor. |
| positionFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| position | Describes the sensed value of the position |
| | sensor in 3D with respect to the default |
| | unit if the unit is not defined. Otherwise, |
| | use the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a velocity sensor type may be represented as in the following Table 113. Herein, Table 113 is a table representing the XML representation syntax of the velocity sensor type.

TABLE 113
<!--#################################### -->

<!--Definition of Velocity Sensor type -->
<!--#################################### -->
<complexType name=“velocitySensorType”>

<complexContent>

<extension base=“iidl:SensedInfoBaseType”>

<sequence>

<element name=“Velocity”

type=“mpegvct:Float3DVectorType” minOccurs=“0”/>

</sequence>
<attribute name=“unit” type=“mpegvct:unitType”

use=“optional”/>

</extension>

</complexContent>

</complexType>

Further, the binary encoding representation scheme or the binary representation of the syntax represented in Table 113 may be represented as the following Table 114. Herein, Table 114 is a table representing the binary representation syntax.

TABLE 114

| | | Number of | |
|---|---|---|---|
| VelocitySensorNormalType{ | | bits | Mnemonic |
| | velocityFlag | 1 | bslbf |
| | unitFlag | 1 | bslbf |
| | SensedInfoBaseType | | SensedInfoBaseTypeType |
| | if(velocityFlag) { | | |

| | |
|---|---|
| velocity | Float3DVectorType |

}
if(unitFlag) {

| | |
|---|---|
| unit | unitType |

}

}

In addition, the semantics of the velocity sensor type are represented as the following Table 115. Herein, Table 115 is a table representing the descriptor components semantics of the position sensor type.

TABLE 115

| Names | Description |
|---|---|
| VelocitySensorType | Tool for describing sensed information with |
| | respect to a velocity sensor. |
| velocityFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| velocity | Describes the sensed value of the velocity |
| | sensor in 3D with respect to the default |
| | unit if the unit is not defined. Otherwise, |
| | use the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of an acceleration sensor type may be represented as in the following Table 116. Herein, Table 116 is a table representing the XML representation syntax of the acceleration sensor type.

TABLE 116
<!--#################################### -->

<!--Definition of Acceleration Sensor type -->
<!--#################################### -->
<complexType name=“AccelerationSensorType”>

<complexContent>

<extension base=“iidl:SensedInfoBaseType”>

<sequence>

<element name=“acceleration”

type=“mpegvct:Float3DVectorType” minOccurs=“0”/>

</sequence>
<attribute name=“unit” type=“mpegvct:unitType”

use=“optional”/>

</extension>

</complexContent>

</complexType>

Further, the binary encoding representation scheme or the binary representation of the syntax represented in Table 116 may be represented as in the following Table 117. Herein, Table 117 is a table representing the binary representation syntax.

TABLE 117

| | | Number of | |
|---|---|---|---|
| AccelerationSensorType{ | | bits | Mnemonic |
| | accelerationFlag | 1 | bslbf |
| | unitFlag | 1 | bslbf |
| | SensedInfoBaseType | | SensedInfoBaseTypeType |
| | if(accelerationFlag) { | | |

| | |
|---|---|
| acceleration | Float3DVectorType |

}
if(unitFlag) {

| | |
|---|---|
| unit | unitType |

}

}

In addition, the semantics of the acceleration sensor type are represented as the following Table 118. Herein, Table 118 is a table representing the descriptor components semantics of the acceleration sensor type.

TABLE 118

| Names | Description |
|---|---|
| AccelerationSensorTyp | Tool for describing sensed information with |
| | respect to an acceleration sensor. |
| accelerationFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| acceleration | Describes the sensed value of the |
| | acceleration sensor in 3D with respect to |
| | the default unit if the unit is not |
| | defined. Otherwise, use the unit type |
| | defined in the sensor capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of an orientation sensor type may be represented as in the following Table 119. Herein, Table 119 is a table representing the XML representation syntax of the orientation sensor type.

TABLE 119

<!--#################################### -->

<!--Definition of Orientation Sensor type -->

<!--#################################### -->

<complexType name=“OrientationSensorType”>

<complexContent>

<extension base=“iidl:SensedInfoBaseType”>

<sequence>

<element name=“orientation”

type=“mpegvct:Float3DVectorType” minOccurs=“0”/>

</sequence>

<attribute name=“unit” type=“mpegvct:unitType”

use=“optional”/>

</extension>

</complexContent>

</complexType>

Further, the binary encoding representation scheme or the binary representation of the syntax represented in Table 119 may be represented as in the following Table 120. Herein, Table 120 is a table representing the binary representation syntax.

TABLE 120

| | Number of | |
|---|---|---|
| OrientationSensorType{ | bits | Mnemonic |
| orientationFlag | 1 | bslbf |
| unitFlag | 1 | bslbf |
| SensedInfoBaseType | | SensedInfoBaseTypeType |
| if(orientationFlag) { | | |
| orientation | | Float3DVectorType |
| } | | |
| if(unitFlag) { | | |
| unit | | unitType |
| } | | |
| } | | |

In addition, the semantics of the orientation sensor type are represented as the following Table 121. Herein, Table 121 is a table representing the descriptor components semantics of the orientation sensor type.

TABLE 121

| Names | Description |
|---|---|
| OrientationSensorType | Tool for describing sensed information with |
| | respect to an orientation sensor. |
| orientationFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| orientation | Describes the sensed value of the |
| | orientation sensor in 3D with respect to |
| | the default unit if the unit is not |
| | defined. Otherwise, use the unit type |
| | defined in the sensor capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of an angular velocity sensor type may be represented as in the following Table 122. Herein, Table 122 is a table representing the XML representation syntax of the angular velocity sensor type.

```
TABLE 122
<!--#################################### -->
  <!--Definition of Angular Velocity Sensor type -->
  <!--#################################### -->
  <complexType name=“AngularVelocitySensorType”>
    <complexContent>
      <extension base=“iidl:SensedInfoBaseType”>
        <sequence>
```

| | |
|---|---|
| <element | name=“AngularVelocity” |

type=“mpegvct:Float3DVectorType” minOccurs=“0”/>
</sequence>

| | |
|---|---|
| <attribute name=“unit” | type=“mpegvct:unitType” |

```
use=“optional”/>
      </extension>
    </complexContent>
</complexType>
```

Further, the binary encoding representation scheme or the binary representation of the syntax represented in Table 122 may be represented as in the following Table 123. Herein, Table 123 is a table representing the binary representation syntax.

TABLE 123

| | Number of | |
|---|---|---|
| AngularVelocitySensorType{ | bits | Mnemonic |
| angularvelocityFlag | 1 | bslbf |
| unitFlag | 1 | bslbf |
| SensedInfoBaseType | | SensedInfoBaseTypeType |
| if(angularvelocityFlag) { | | |
| angularvelocity | | Float3DVectorType |
| } | | |
| if(unitFlag) { | | |
| unit | | unitType |
| } | | |
| } | | |

In addition, the semantics of the angular velocity sensor type are represented as the following Table 124. Herein, Table 124 is a table representing the descriptor components semantics of the angular velocity sensor type.

TABLE 124

| Names | Description |
|---|---|
| AngularVelocitySensorType | Tool for describing sensed information |
| | with respect to an angular velocity |
| | sensor. |
| angularvelocityFlag | This field, which is only present in the |
| | binary representation, signals the |
| | presence of sensor value attribute. A |
| | value of “1” means the attribute shall be |
| | used and “0” means the attribute shall |
| | not be used. |
| unitFlag | This field, which is only present in the |
| | binary representation, signals the |
| | presence of unit attribute. A value of |
| | “1” means the user-defined unit shall |
| | be used and “0” means the user-defined |
| | unit shall not be used. |
| SensedInfoBaseType | Provides the topmost type of the base |
| | type hierarchy which each individual |
| | sensed information can inherit. |
| angularvelocity | Describes the sensed value of the |
| | angular velocity sensor in 3D with |
| | respect to the default unit if the unit is |
| | not defined. Otherwise, use the unit type |
| | defined in the sensor capability. |
| unit | Specifies the unit of the sensed value, if |
| | a unit other than the default unit is used, |
| | as a reference to a classification scheme |
| | term provided by UnitCS defined in xxx |
| | of ISO/IEC 23005-6 and use the binary |
| | representation defined above. |

Next, the XML representation syntax of an angular acceleration sensor type may be represented as in the following Table 125. Herein, Table 125 is a table representing the XML representation syntax of the angular acceleration sensor type.

TABLE 125

```
<!--############################################### -->
  <!--Definition of Angular Acceleration Sensor type -->
  <!--############################################### -->
  <complexType name=“AngularAccelerationSensorType”>
    <complexContent>
      <extension base=“iidl:SensedInfoBaseType”>
        <sequence>
          <element name=“AngularAcceleration”
type=“mpegvct:Float3DVectorType” minOccurs=“0”/>
        </sequence>
        <attribute name=“unit”  type=“mpegvct:unitType”
use=“optional”/>
      </extension>
    </complexContent>
</complexType>
```

Further, the binary encoding representation scheme or the binary representation of the syntax represented in Table 125 may be represented as in the following Table 126. Herein, Table 126 is a table representing the binary representation syntax.

TABLE 126

| | Number | |
|---|---|---|
| | of | |
| AngularAccelerationSensorType{ | bits | Mnemonic |
| angularaccelerationFlag | 1 | bslbf |
| unitFlag | 1 | bslbf |
| SensedInfoBaseType | | SensedInfoBaseTypeType |
| if(angularaccelerationFlag) | | |
| { | | |
| angularacceleration | | Float3DVectorType |
| } | | |
| if(unitFlag) { | | |
| unit | | unitType |
| } | | |
| } | | |

In addition, the semantics of the angular acceleration sensor type are represented as the following Table 127. Herein, Table 127 is a table representing the descriptor components semantics of the angular acceleration sensor type.

TABLE 127

| Names | Description |
|---|---|
| AngularAccelerationSensorType | Tool for describing sensed |
| | information with respect to an |
| | angular acceleration sensor |
| angularacceleration | This field, which is only present in the |
| Flag | binary representation, signals the |
| | presence of sensor value attribute. A |
| | value of “1” means the attribute |
| | shall be used and “0” means the |
| | attribute shall not be used. |
| unitFlag | This field, which is only present in the |
| | binary representation, signals the |
| | presence of unit attribute. A value of |
| | “1” means the user-defined unit shall |
| | be used and “0” means the user- |
| | defined unit shall not be used. |
| SensedInfoBaseType | Provides the topmost type of the base |
| | type hierarchy which each individual |
| | sensed information can inherit. |
| angularacceleration | Describes the sensed value of the |
| | angular acceleration sensor in 3D |
| | with respect to the default unit if the |
| | unit is not defined. Otherwise, use the |
| | unit type defined in the sensor |
| | capability. |
| unit | Specifies the unit of the sensed value, |
| | if a unit other than the default unit is |
| | used, as a reference to a classification |
| | scheme term provided by UnitCS |
| | defined in xxx of ISO/IEC 23005-6 |
| | and use the binary representation |
| | defined above. |

Next, the XML representation syntax of a force sensor type may be represented as in the following Table 128. Herein, Table 128 is a table representing the XML representation syntax of the force sensor type.

```
TABLE 128
<!--#################################### -->
  <!--Definition of Force Sensor type -->
  <!--#################################### -->
  <complexType name=“ForceSensorType”>
    <complexContent>
      <extension base=“iidl:SensedInfoBaseType”>
        <sequence>
          <element name=“force”
type=“mpegvct:Float3DVectorType” minOccurs=“0”/>
        </sequence>
        <attribute name=“unit”  type=“mpegvct:unitType”
use=“optional”/>
      </extension>
    </complexContent>
</complexType>
```

Further, the binary encoding representation scheme or the binary representation of the syntax represented in Table 128 may be represented as the following Table 129. Herein, Table 129 is a table representing the binary representation syntax.

TABLE 129

| | Number of | |
|---|---|---|
| ForceSensorType{ | bits | Mnemonic |
| forceFlag | 1 | bslbf |
| unitFlag | 1 | bslbf |
| SensedInfoBaseType | | SensedInfoBaseTypeType |
| if(forceFlag) { | | |
| force | | Float3DVectorType |
| } | | |
| if(unitFlag) { | | |
| unit | | unitType |
| } | | |
| } | | |

In addition, the semantics of the force sensor type are represented as the following Table 130. Herein, Table 130 is a table representing the descriptor components semantics of the force sensor type.

TABLE 130

| Names | Description |
|---|---|
| ForceSensorType | Tool for describing sensed information with |
| | respect to a force sensor |
| forceFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| force | Describes the sensed value of the force |
| | sensor in 3D with respect to the default |
| | unit if the unit is not defined. Otherwise, |
| | use the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a torque sensor type may be represented as in the following Table 131. Herein, Table 131 is a table representing the XML representation syntax of the torque sensor type.

```
TABLE 131
<!--#################################### -->
  <!--Definition of Torque Sensor type -->
  <!--#################################### -->
  <complexType name=“TorqueSensorType”>
    <complexContent>
      <extension base=“iidl:SensedInfoBaseType”>
        <sequence>
          <element name=“Torque”
type=“mpegvct:Float3DVectorType” minOccurs=“0”/>
        </sequence>
        <attribute name=“unit”  type=“mpegvct:unitType”
use=“optional”/>
      </extension>
    </complexContent>
</complexType>
```

Further, the binary encoding representation scheme or the binary representation of the syntax represented in Table 131 may be represented as the following Table 132. Herein, Table 132 is a table representing the binary representation syntax.

TABLE 132

| | Number of | |
|---|---|---|
| TorqueSensorType{ | bits | Mnemonic |
| TorqueFlag | 1 | bslbf |
| unitFlag | 1 | bslbf |
| SensedInfoBaseType | | SensedInfoBaseTypeType |
| if(torqueFlag) { | | |
| torque | | Float3DVectorType |
| } | | |
| if(unitFlag) { | | |
| unit | | unitType |
| } | | |
| } | | |

In addition, the semantics of the torque sensor type are represented as the following Table 133. Herein, Table 133 is a table representing the descriptor components semantics of the torque sensor type.

TABLE 133

| Names | Description |
|---|---|
| TorqueSensorType | Tool for describing sensed information with |
| | respect to a torque sensor |
| torqueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| torque | Describes the sensed value of the torque |
| | sensor in 3D with respect to the default |
| | unit if the unit is not defined. |
| | Otherwise, use the unit type defined in the |
| | sensor capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a pressure sensor type may be represented as in the following Table 134. Herein, Table 134 is a table representing the XML representation syntax of the pressure sensor type.

```
TABLE 134
<!--#################################### -->
  <!--Definition of Pressure Sensor type -->
  <!--#################################### -->
  <complexType name=“PressureSensorType”>
    <complexContent>
      <extension base=“iidl:SensedInfoBaseType”>
        <attribute name=“value” type=“float” use=“optional”/>
        <attribute name=“unit”  type=“mpegvct:unitType”
use=“optional”/>
      </extension>
    </complexContent>
</complexType>
```

Further, the binary encoding representation scheme or the binary representation of the syntax represented in Table 134 may be represented as the following Table 135. Herein, Table 135 is a table representing the binary representation syntax.

TABLE 135

| | Number of | |
|---|---|---|
| PressureSensorType{ | bits | Mnemonic |
| valueFlag | 1 | bslbf |
| unitFlag | 1 | bslbf |
| SensedInfoBaseType | | SensedInfoBaseTypeType |
| if(valueFlag) { | | |
| value | 32 | fsbf |
| } | | |
| if(unitFlag) { | | |
| unit | | unitType |
| } | | |
| } | | |

In addition, the semantics of the pressure sensor type are represented as the following Table 136. Herein, Table 136 is a table representing the descriptor components semantics of the pressure sensor type.

TABLE 136

| Names | Description |
|---|---|
| PressureSensorType | Tool for describing sensed information with |
| | respect to a pressure sensor. |
| valueFlag | This field, which is only present in the |
| | binary representation, signals the presence |
| | of sensor value attribute. A value of “1” |
| | means the attribute shall be used and “0” |
| | means the attribute shall not be used. |
| unitFlag | This field, which is only present in the |
| | binary representation, signals the presence |
| | of unit attribute. A value of “1” means |
| | the user-defined unit shall be used and |
| | “0” means the user-defined unit shall not |
| | be used. |
| SensedInfoBaseType | Provides the topmost type of the base type |
| | hierarchy which each individual sensed |
| | information can inherit. |
| value | Describes the sensed value of the pressure |
| | sensor with respect to the default unit if |
| | the unit is not defined. Otherwise, use |
| | the unit type defined in the sensor |
| | capability. |
| unit | Specifies the unit of the sensed value, if |
| | a unit other than the default unit is used, |
| | as a reference to a classification scheme |
| | term provided by UnitCS defined in xxx of |
| | ISO/IEC 23005-6 and use the binary |
| | representation defined above. |

Next, the XML representation syntax of a motion sensor type may be represented as in the following Table 137. Herein, Table 137 is a table representing the XML representation syntax of the motion sensor type.

```
TABLE 137
<!-- ################################################ -->
  <!-- Definition of Motion Sensor Type -->
  <!-- ################################################ -->
  <complexType name=“MotionSensorType”>
    <complexContent>
      <extension base=“iidl:SensedInfoBaseType”>
        <sequence>
          <element name=“position”
type=“siv:PositionSensorType” minOccurs=“0”/>
          <element name=“orientation”
type=“siv:OrientationSensorType” minOccurs=“0”/>
          <element name=“velocity”
type=“siv:VelocitySensorType” minOccurs=“0”/>
          <element name=“angularvelocity”
type=“siv:AngularVelocitySensorType” minOccurs=“0”/>
          <element name=“acceleration”
type=“siv:AccelerationSensorType” minOccurs=“0”/>
          <element name=“angularacceleration”
type=“siv:AngularAccelerationSensorType” minOccurs=“0”/>
        </sequence>
      </extension>
    </complexContent>
</complexType>
```

Further, the binary encoding representation scheme or the binary representation of the syntax represented in Table 137 may be represented as in the following Table 138. Herein, Table 138 is a table representing the binary representation syntax.

TABLE 138

| | Number of | |
|---|---|---|
| MotionSensorType{ | bits | Mnemonic |
| positionFlag | 1 | bslbf |
| orientationFlag | 1 | bslbf |
| velocityFlag | 1 | bslbf |
| angularvelocityFlag | 1 | bslbf |
| accelerationFlag | 1 | bslbf |
| angularaccelerationFlag | 1 | bslbf |
| SensedInfoBaseType | | SensedInfoBaseTypeType |
| if(positionFlag) { | | |
| position | | PositionSensorType |
| } | | |
| if(orientationFlag) { | | |
| orientation | | OrientationSensorType |
| } | | |
| if(velocityFlag) { | | |
| velocity | | VelocitySensorType |
| } | | |
| if(angularvelocityFlag) { | | |
| angularvelocity | | AngularVelocitySensor |
| } | | Type |
| if(accelerationFlag) { | | |
| acceleration | | AccelerationSensorType |
| } | | |
| if(angularaccelerationFlag) | | |
| { | | |
| angularacceleration | | AngularAcceleration |
| | | SensorType |
| } | | |

In addition, the semantics of the motion sensor type are represented as the following Table 139. Herein, Table 139 is a table representing the descriptor components semantics of the motion sensor type.

TABLE 139

| Names | Description |
|---|---|
| MotionSensorType | Tool for describing sensed information with |
| | respect to a motion sensor. |
| positionFlag | This field, which is only present in the |
| | binary representation, signals the presence |
| | of sensor value attribute. A value of “1” |
| | means the attribute shall be used and “0” |
| | means the attribute shall not be used. |
| orientationFlag | This field, which is only present in the |
| | binary representation, signals the presence |
| | of sensor value attribute. A value of “1” |
| | means the attribute shall be used and “0” |
| | means the attribute shall not be used. |
| velocityFlag | This field, which is only present in the |
| | binary representation, signals the presence |
| | of sensor value attribute. A value of “1” |
| | means the attribute shall be used and “0” |
| | means the attribute shall not be used. |
| angularvelocityFlag | This field, which is only present in the |
| | binary representation, signals the presence |
| | of sensor value attribute. A value of “1” |
| | means the attribute shall be used and “0” |
| | means the attribute shall not be used. |
| accelerationFlag | This field, which is only present in the |
| | binary representation, signals the presence |
| | of sensor value attribute. A value of “1” |
| | means the attribute shall be used and “0” |
| | means the attribute shall not be used. |
| angularaccelerationFlag | This field, which is only present in the |
| | binary representation, signals the presence |
| | of sensor value attribute. A value of “1” |
| | means the attribute shall be used and “0” |
| | means the attribute shall not be used. |
| SensedInfoBaseType | Provides the topmost type of the base type |
| | hierarchy which each individual sensed |
| | information can inherit. |
| position | Describes the sensed position value of the |
| | motion sensor with respect to the default |
| | unit if the unit is not defined. Otherwise, |
| | use the unit type defined in the sensor |
| | capability |
| orientation | Describes the sensed orientation value of |
| | the motion sensor with respect to the |
| | default unit if the unit is not defined. |
| | Otherwise, use the unit type defined in the |
| | sensor capability. |
| velocity | Describes the sensed velocity value of the |
| | motion sensor with respect to the default |
| | unit if the unit is not defined. |
| | Otherwise, use the unit type defined in the |
| | sensor capability. |
| angularvelocity | Describes the sensed velocity value of the |
| | motion sensor with respect to the default |
| | unit if the unit is not defined. Otherwise, |
| | use the unit type defined in the sensor |
| | capability. |
| acceleration | Describes the sensed acceleration value of |
| | the motion sensor with respect to the |
| | default unit if the unit is not defined. |
| | Otherwise, use the unit type defined in the |
| | sensor capability. |
| angularacceleration | Describes the sensed angular acceleration |
| | value of the motion sensor with respect to |
| | the default unit if the unit is not |
| | defined. Otherwise, use the unit type |
| | defined in the sensor capability. |

Next, the XML representation syntax of an intelligent camera type may be represented as in the following Table 140. Herein, Table 140 is a table representing the XML representation syntax of the intelligent camera type.

```
TABLE 140
<!-- ################################################ -->
  <!-- Definition of Intelligent Camera Type -->
  <!-- ################################################ -->
  <complexType name=“IntelligentCameraType”>
    <complexContent>
      <extension base=“iidl:SensedInfoBaseType”>
        <sequence>
          <element name=“FacialAnimationID”  type=“anyURI”
minOccurs=“0”/>
          <element name=“BodyAnimationID”  type=“anyURI”
minOccurs=“0”/>
          <element name=“FaceFeature”
type=“mpegvct:Float3DVectorType”  minOccurs=“0”
maxOccurs=“255”/>
          <element name=“BodyFeature”
type=“mpegvct:Float3DVectorType”  minOccurs=“0”
maxOccurs=“255”/>
        </sequence>
      </extension>
    </complexContent>
</complexType>
```

Further, the binary encoding representation scheme or the binary representation of the syntax represented in Table 140 may be represented as in the following Table 141. Herein, Table 141 is a table representing the binary representation syntax.

TABLE 141

| | Number | |
|---|---|---|
| | of | |
| IntelligentCameraType{ | bits | Mnemonic |
| FacialIDFlag | 1 | bslbf |
| BodyIDFlag | 1 | bslbf |
| FaceFeatureFlag | 1 | bslbf |
| BodyFeatureFlag | 1 | bslbf |
| SensedInfoBaseType | | SensedInfoBaseTypeType |
| if( FacialIDFlag ) { | | |
| FacialAnimationID | | UTF-8 |
| } | | |
| if( BodyIDFlag ) { | | |
| BodyAnimationID | | UTF-8 |
| } | | |
| if( FaceFeatureFlag ) { | | |
| NumOfFaceFeature | 8 | uimsbf |
| for( k=0; | | |
| k<NumOfFaceFeature; | | |
| k++ ) { | | |
| FaceFeature[k] | | Float3DVectorType |
| } | | |
| } | | |
| if( BodyFeatureFlag ) { | | |
| NumOfBodyFeature | 8 | uimsbf |
| for( k=0; | | |
| k<NumOfBodyFeature; | | |
| k++ ) { | | |
| BodyFeature[k] | | Float3DVectorType |
| } | | |
| } | | |
| } | | |

In addition, the semantics of the intelligent camera type are represented as the following Table 142. Herein, Table 142 is a table representing the descriptor components semantics of the intelligent camera type.

TABLE 142

| Names | Description |
|---|---|
| IntelligentCameraType | Tool for describing sensed information with |
| | respect to an intelligent camera sensor. |
| FacialIDFlag | This field, which is only present in the |
| | binary representation, signals the presence |
| | of the facial animation ID. A value of |
| | “1” means the facial animation ID mode |
| | shall be used and “0” means the facial |
| | animation ID mode shall not be used. |
| BodyIDFlag | This field, which is only present in the |
| | binary representation, signals the presence |
| | of the body animation ID. A value of “1” |
| | means the body animation ID mode shall be |
| | used and “0” means the body animation ID |
| | mode shall not be used. |
| FaceFeatureFlag | This field, which is only present in the |
| | binary representation, signals the presence |
| | of the face features. A value of “1” means |
| | the face feature tracking mode shall be |
| | used and “0” means the face feature |
| | tracking mode shall not be used. |
| BodyFeatureFlag | This field, which is only present in the |
| | binary representation, signals the presence |
| | of the body features. A value of “1” means |
| | the body feature tracking mode shall be |
| | used and “0” means the body feature |
| | tracking mode shall not be used. |
| SensedInfoBaseType | Provides the topmost type of the base type |
| | hierarchy which each individual sensed |
| | information can inherit. |
| FacialAnimationID | Describes the ID referencing the facial |
| | expression animation clip. |
| BodyAnimationID | Describes the ID referencing the body |
| | animation clip. |
| NumOfFaceFeature | This field, which is only present in the |
| | binary representation, specifies the number |
| | of face feature points. |
| FaceFeature | Describes the 3D position of each of the |
| | face feature points detected by the camera. |
| | Note: The order of the elements corresponds |
| | to the order of the face feature points |
| | defined at the featureControl for face in |
| | 2.2.15 of ISO/IEC_23005-4 |
| NumOfBodyFeature | This field, which is only present in the |
| | binary representation, specifies the number |
| | of body feature points. |
| BodyFeature | Describes the 3D position of each of the |
| | body feature points detected by the camera. |
| | Note: The order of the elements corresponds |
| | to the order of the body feature points |
| | defined at the featureControl for body in |
| | 2.2.14 of ISO/IEC_23005-4. |

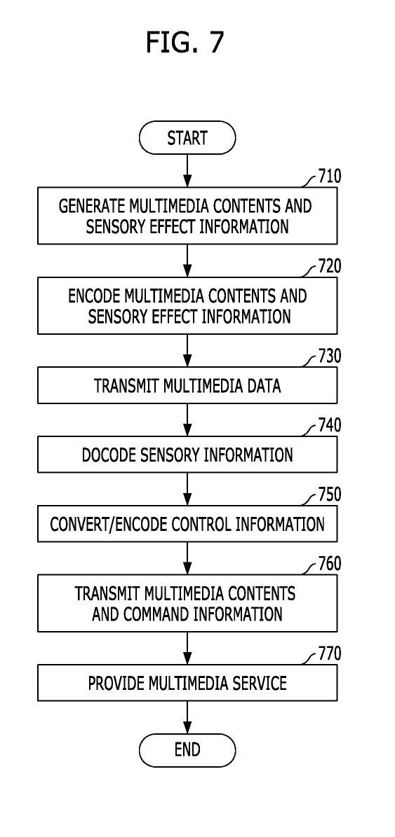

Hereinafter, an operation of the system for providing multimedia services in accordance with an exemplary embodiment of the present invention will be described in more detail with reference to FIG. 7.

FIG. 7 is a diagram schematically illustrating a process of providing multimedia services of the system for providing multimedia services in accordance with the exemplary embodiment of the present invention.

Referring to FIG. 7, at step 710, the service provider of the system for providing multimedia services generates the multimedia contents of the multimedia services to be provided to the users and the sensory effect information of the multimedia contents depending on the service requests of the users.

Further, at step 720, the service provider encodes the generated multimedia contents and encodes the sensory effect information by the binary representation, that is, the binary representation encoding scheme. In this case, the binary representation encoding of the sensory effect information will be described in detail and therefore, the detailed description thereof will be omitted herein.

Then, at step 730, the service provider transmits the multimedia data including the encoded multimedia contents and the multimedia data including the sensory effect information encoded by the binary representation.

Next, at step 740, the user server of the system for providing multimedia services receives the multimedia data and decodes the sensory effect information encoded by the binary representation in the received multimedia data.

In addition, at step 750, the user server converts the sensory effect information into the command information in consideration of the capability information of each user device and encodes the converted command information using the binary representation, that is, the binary representation encoding scheme. In this case, the conversion of the command information and the binary representation encoding of the command information will be described in detail and therefore, the detailed description thereof will be omitted herein.

Then, at step 5760, the user server transmits the multimedia contents and the command information encoded by the binary representation to the user devices, respectively.

Further, at step 770, each user device of the system for providing multimedia services simultaneously provides the multimedia contents and the sensory effects of the multimedia contents through the device command by the command information encoded by the binary representation to the users in real time, that is, the high quality of various multimedia services.

The exemplary embodiment of the present invention may stably provide the high quality of various multimedia services that the users want to receive in the communication system, in particular, provide the multimedia contents of the multimedia services and the various sensory effects of the multimedia contents to each user. In addition, the exemplary embodiments of the present invention encodes the information representing the various sensory effects of the multimedia contents using the binary representation to transmit the multimedia contents and the various sensory effects of the multimedia contents at high speed, such that the multimedia contents and the sensory effects may be provided to each user in real time, that is, the high quality of various multimedia services may be provided to the users in real time.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

What is claimed is:

1. A system for providing multimedia service in a communication service, comprising:
a user server configured to receive sensory effect information representing sensory effects of multimedia contents corresponding to the multimedia services and encode the sensory effect information into command information of binary representation to be transmitted to user devices, respectively, depending on service requests of multimedia services that users want to receive; and
user devices configured to provide the multimedia contents and the sensory effects to the users through device command for command information of the binary representation in real time.

2. The system of claim 1, wherein the user server encodes the sensory effect information into the command information of the binary representation for device command for the user devices in consideration of capability information of the user devices.

3. The system of claim 2, wherein the user server receives sensory effect information of an eXtensible markup language (XML) document or receives the sensory effect information encoded by the binary representation.

4. The system of claim 3, wherein the user server converts the sensory effect information into the command information for the command control of the user devices in consideration of the capability information of the user devices and encodes the converted command information into the command information of the binary representation using the binary representation encoding scheme.

5. The system of claim 3, wherein the user server decodes the sensory effect information encoded by the binary representation and encodes the decoded sensory effect information into the command information of the binary representation in consideration of the capability information of the user devices.

6. The system of claim 2, wherein the user server encodes the sensory effect information into a device control stream of the binary representation to be transmitted to the user devices, respectively, for the device command of the user devices

7. The system of claim 2, wherein the sensory effects includes a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, a tactile effect.

8. The system of claim 7, wherein the user server defines syntax, binary representation, and semantics of the sensory effects.

9. A system for providing multimedia services in a communication system, comprising:
a receiver configured to receive sensory effect information representing sensory effects of multimedia contents corresponding to the multimedia services depending on service requests of multimedia services that users want to receive;
an encoder configured to encode the sensory effect information into command information of binary representation using a binary representation encoding scheme; and
a transmitter configured to transmit command information of the binary representation to the user devices, respectively, so as to provide the sensory effects to the users through the device command of the user devices depending on the command information of the binary representation.

10. The system of claim 9, wherein the encoder encodes the sensory effect information into the command information of the binary representation, in consideration of capability information of the user devices.

11. The system of claim 10, wherein the receiver receives sensory effect information of an eXtensible markup language (XML) document or receives the sensory effect information encoded by the binary representation.

12. The system of claim 11, further comprising a converter configured to convert the sensory effect information into the command information for the device command of the user devices in consideration of the capability information of the user devices,
wherein the encoder encodes the converted command information into the command information of the binary representation using the binary representation encoding scheme.

13. The system of claim 11, further a decoder configured to decode the sensory effect information encoded by the binary representation,
wherein the encoder encodes the decoded sensory effect information into the command information of the binary representation in consideration of the capability information of the user devices.

14. The system of claim 10, wherein the sensory effects include a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, a tactile effect.

15. The system of claim 14, wherein the encoder defines syntax, binary representation, and semantics of the sensory effects.

16. A method for providing multimedia services in a communication system, comprising:
receiving sensory effect information representing sensory effects of multimedia contents corresponding to the multimedia services depending on service requests of multimedia services that users want to receive;
encoding the sensory effect information into command information of binary representation; and
transmitting command information of the binary representation to the user devices, respectively, so as to provide the sensory effects to the users through the device command of the user devices depending on the command information of the binary representation.

17. The method of claim 16, wherein the receiving receives the sensory effect information on the eXtensible Markup Language (XML) document, and
the encoding converts the sensory effect information into the command information for the device command of the user devices in consideration of the capability information of the user devices and then, encodes the converted command information into the command information of the binary representation.

18. The method of claim 16, wherein the receiving receives the sensory effect information encoded by the binary representation, and
the encoding decodes the sensory effect information encoded by the binary representation and then, encodes the decoded sensory effect information into the control information of the binary representation in consideration of the capability information of the user devices.

19. The method of claim 16, wherein the sensory effects include a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, a tactile effect.

20. The method of claim 19, wherein the encoding using the binary representation defines syntax, binary representation, and semantics of the sensory effects.
